(19) United States
(12) Patent Application Publication
(10) Pub. No.: US 2023/0085225 A1
(43) Pub. Date: Mar. 16, 2023

(54) SYSTEMS AND METHODS FOR GENERATING AND CURATING TASKS

(71) Applicant: Yohana LLC, Palo Alto, CA (US)

(72) Inventors: Yoky Matsuoka, Los Altos Hills, CA (US); Nitin Viswanathan, San Francisco, CA (US); Gwendolyn W. van der Linden, Redwood City, CA (US); Malia Beaulieu, San Jose, CA (US); Lingyun Liu, Sunnyvale, CA (US); Benjamin Deming, Campbell, CA (US); Sean Paterson, Mountain View, CA (US)

(21) Appl. No.: 17/817,545

(22) Filed: Aug. 4, 2022

Related U.S. Application Data
(60) Provisional application No. 63/229,269, filed on Aug. 4, 2021.

(51) Int. Cl. G06Q 10/06; G06F 40/40

(52) U.S. Cl. CPC G06Q 10/06316; G06Q 10/06311; G06F 40/40

(57) ABSTRACT

Systems and methods for generating and curating projects and tasks based on messages exchanged between members and assigned representatives are provided. A system receives, in real-time, a set of messages between a member and a representative as the set of messages are being exchanged. The system, based on these messages, automatically identifies a task that can be performed for the benefit of the member. The system can further identify additional information required for defining the task based on the member's preferences. The system can dynamically generate prompts for this additional information, which are provided to the member to obtain the additional information. The task is updated based on the additional information and is performed according to the parameters of the task and the additional information.

### CROSS-REFERENCE TO RELATED APPLICATIONS

The present patent application claims the priority benefit of U.S. provisional patent application No. 63/229,269 filed Aug. 4, 2021, the disclosures of which are incorporated by reference herein.

### FIELD

The present disclosure relates to systems and methods for generating and curating projects and tasks based on messages exchanged between members and assigned representatives. In one example, the systems and methods described herein may be used to identify and create tasks that may be performed for the benefit of a member. Further, the systems and methods described herein may be used to provide automated coordination for the performance of these tasks.

### SUMMARY

Disclosed embodiments may provide a framework to identify and create tasks that may be performed for the benefit of the member based on real-time evaluations of messages communicated between members and assigned representatives as these messages are exchanged. According to some embodiments, a computer-implemented method is provided. The computer-implemented method comprises receiving in real-time a set of messages between a member and a representative as the set of messages are being exchanged. The computer-implemented method further comprises automatically identifying in real-time a task performable on behalf of the member and one or more parameters associated with the task. The task and the one or more parameters associated with the task are identified based on the set of messages. The computer-implemented method further comprises identifying additional information required for defining the task. The additional information is identified using a trained machine learning algorithm. Further, the trained machine learning algorithm uses a profile corresponding to the member, the task, and the one or more parameters associated with the task to identify the additional information. The computer-implemented method further comprises dynamically generating one or more prompts for the additional information. When the one or more prompts are generated, the one or more prompts are provided to the member to obtain the additional information. The computer-implemented method further comprises updating the task based on the additional information. The computer-implemented method further comprises performing the task. The task is performed according to the one or more parameters associated with the task and the additional information. The computer-implemented method further comprises updating the trained machine learning algorithm. The trained machine learning algorithm is updated using the task, the one or more parameters, the additional information, and the profile corresponding to the member.

In some embodiments, the computer-implemented further comprises monitoring in real-time new messages between the member and the representative as the new messages are exchanged. The new messages correspond to the one or more prompts for the additional information. The computer-implemented method further comprises processing the new messages using a Natural Language Processing (NLP) algorithm to obtain the additional information.

In some embodiments, the computer-implemented further comprises facilitating a communications session corresponding to the task. The communications session is facilitated between the member and the representative. The computer-implemented method further comprises automatically presenting the one or more prompts for the additional information through the communications session.

In some embodiments, the computer-implemented further comprises generating one or more proposal options for completion of the task. The one or more proposal options are generated based on the task and the profile corresponding to the member. Further, when a proposal option is selected, the task is performed according to the selected proposal option.

In some embodiments, the computer-implemented further comprises selecting a task template. The task template is selected based on the one or more parameters associated with the task. The computer-implemented further comprises updating the task template according to the one or more parameters. The computer-implemented method further comprises completing the task template using the additional information. When the task template is completed, the task is presented.

In some embodiments, the computer-implemented further comprises providing the one or more prompts to the representative. When the one or more prompts are received by the representative, the representative presents one or more new messages including the one or more prompts to the member.

In some embodiments, the computer-implemented further comprises receiving in real-time a new message exchanged between the member and the representative. The new message indicates a request for new information required for the task. The computer-implemented method further comprises modifying the task to incorporate the new information. The computer-implemented method further comprises updating the trained machine learning algorithm and the profile corresponding to the member based on the request.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a project and corresponding tasks are generated and provided by a task facilitation service in accordance with at least one embodiment;

FIG. 2 shows an illustrative example of an environment in which a task recommendation system generates and ranks recommendations for different projects and/or tasks that can be presented to a member in accordance with at least one embodiment;

FIG. 3 shows an illustrative example of an environment in which a machine learning algorithm or artificial intelligence is implemented to assist in the identification and creation of new projects and tasks in accordance with at least one embodiment;

FIG. 4 shows an illustrative example of an environment in which a machine learning algorithm or artificial intelligence is implemented to process messages exchanged between a member and a representative to inform a representative of new projects and tasks in accordance with at least one embodiment;

FIG. 5 shows an illustrative example of an environment in which a task creation sub-system provides, via a representative console, a task template for the creation of a new task to be performed for the benefit of a member in accordance with at least one embodiment;

FIG. 6 shows an illustrative example of an environment in which a machine learning algorithm or artificial intelligence automatically identifies additional information that is required from a member for defining new projects and tasks in accordance with at least one embodiment;

FIG. 7 shows an illustrative example of an environment in which a task coordination system assigns and monitors performance of a task for the benefit of a member by a representative and/or one or more third-party services in accordance with at least one embodiment;

FIG. 8 shows an illustrative example of a process for generating new projects and/or tasks based on messages exchanged between a member and an assigned representative in accordance with at least one embodiment;

FIG. 9 shows an illustrative example of a process for identifying additional information required from a member for defining new projects and/or tasks based on a member profile in accordance with at least one embodiment;

FIG. 10 shows an illustrative example of an environment in which communications with members are processed in accordance with at least one embodiment; and

FIG. 11 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework to automatically identify and recommend tasks and/or projects to a member of a task facilitation service in order to reduce the member's cognitive load. Through this framework, the task facilitation service can monitor, in real-time, communications between a member and an assigned representative to automatically identify possible tasks that can be performed for the benefit of the member as these communications are exchanged. Further, the task facilitation service can automatically, and in real-time, identify any additional information that may be required for the creation of these tasks. Once these tasks have been created, the task facilitation service can coordinate with the representative and/or third-party services to perform these tasks for the benefit of the member.

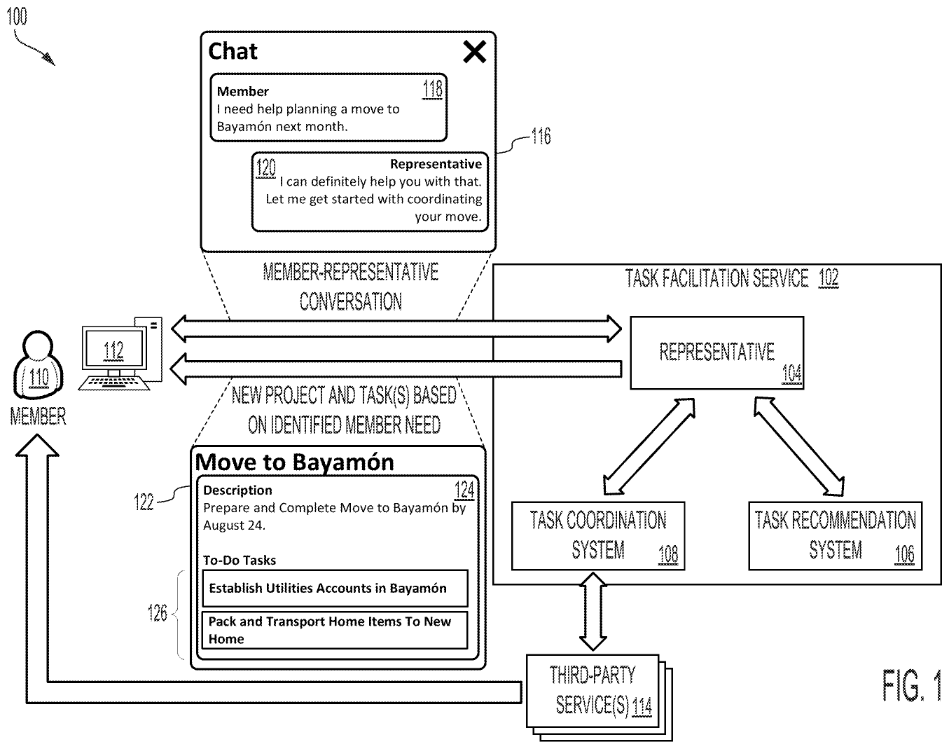

FIG. 1 shows an illustrative example of an environment 100 in which a project 124 and corresponding tasks 126 are generated and provided by a task facilitation service 102 in accordance with at least one embodiment. In the environment 100, a member 110 of the task facilitation service 102 may be engaged in with an assigned representative 104 through a communication session 116 facilitated by the task facilitation service 102. The member 110, through the communications session 116, may transmit one or more messages 118 to the representative 104 to indicate that the member 110 requires assistance in completing a project and/or task for the benefit of the member 110. For example, as illustrated in FIG. 1, the member 110 may indicate that they require the representative's assistance in planning a move to a new city in the next month. The representative 104, in response to these one or more messages 118 may indicate, via one or more messages 120, that they may be able to assist the member 110 in completing the particular project and/or task through various methods available to the representative 104 and/or implemented by the task facilitation service 102, as described herein.

The task facilitation service 102 may be implemented to reduce the cognitive load on members and their families in performing various projects and tasks on behalf of these members and their families by identifying and delegating tasks to representatives that may coordinate performance of these tasks. A member, such as member 110, may be paired with a representative 104 during an onboarding process, through which the task facilitation service 102 may collect identifying information of the member 110. For instance, the task facilitation service 102 may provide, to the member 110, a survey or questionnaire through which the member 110 may provide identifying information usable to select a representative 104 for the member 110. The task facilitation service 102 may prompt the member 110 to provide detailed information with regard to the composition of the member's family (e.g., number of inhabitants in the member's home, the number of children in the member's home, the number and types of pets in the member's home, etc.), the physical location of the member's home, any special needs or requirements of the member 110 (e.g., physical or emotional disabilities, etc.), and the like. In some instances, the member 110 may be prompted to provide demographic information (e.g., age, ethnicity, race, languages written/spoken, etc.). The member 110 may also be prompted to indicate any information related to one or more tasks that the member 110 wishes to possibly delegate to a representative 104. This information may specify the nature of these tasks (e.g., gutter cleaning, installation of carbon monoxide detectors, party planning, etc.), a level of urgency for completion of these tasks (e.g., timing requirements, deadlines, date corresponding to upcoming events, etc.), any member preferences for completion of these tasks, and the like.

In an embodiment, the data associated with the member 110 is used by the task facilitation service 102 to create a member profile corresponding to the member 110. As noted above, the task facilitation service 102 may provide, to the member 110, a survey or questionnaire through which the member 110 may provide identifying information associated with the member 110. The responses provided by the member 110 to this survey or questionnaire may be used by the task facilitation service 102 to generate an initial member profile corresponding to the member 110. In an embodiment, once a representative has been assigned to the member 110, the task facilitation service 102 can prompt the member 110 to generate a new member profile corresponding to the member 110. For instance, the task facilitation service 102 may provide the member 110 with a survey or questionnaire that includes a set of questions that may be used to supplement the information previously provided during the aforementioned onboarding process. For example, through the survey or questionnaire, the task facilitation service 102 may prompt the member 110 to provide additional information about family members, important dates (e.g., birthdays, etc.), dietary restrictions, and the like. Based on the responses provided by the member 110, the task facilitation service 102 may update the member profile corresponding to the member 110.

In some instances, the member profile may be accessible to the member 110, such as through an application or web portal provided by the task facilitation service 102. Through the application or web portal, the member 110 may add, remove, or edit any information within the member profile. The member profile, in some instances, may be divided into various sections corresponding to the member, the member's family, the member's home, and the like. Each of these sections may be supplemented based on the data associated with the member 110 collected during the onboarding process and on any responses to the survey or questionnaire provided to the member 110 after assignment of a representative to the member 110. Additionally, each section may include additional questions or prompts that the member 110 may use to provide additional information that may be used to expand the member profile. For example, through the member profile, the member 110 may be prompted to provide any credentials that may be used to access any external accounts (e.g., credit card accounts, retailer accounts, etc.) in order to facilitate completion of tasks and projects.

The collected identifying information may be used by the task facilitation service 102 to identify and assign a representative 104 to the member 110. For instance, the task facilitation service 102 may use the identifying information of a member 110, as well as any information related to the member's level of comfort or interest in delegating tasks to others, and any other information obtained during the onboarding process as input to a classification or clustering algorithm configured to identify representatives that may be well-suited to interact and communicate with the member 110 in a productive manner. Using the classification or clustering algorithm, the task facilitation service 102 may identify a representative 104 that may be more likely to develop a positive, long-term relationship with the member 110 while addressing any tasks that may need to be addressed for the benefit of the member 110. In some instances, the task facilitation service 102 may select a representative 104 based on information corresponding to the availability of the set of representatives associated with the task facilitation service 102. For instance, the task facilitation service 102 may automatically select the first available representative from a set of representatives. In some instances, the task facilitation service 102 may automatically select the first available representative that satisfies one or more criteria corresponding to the member's identifying information. For example, the task facilitation service 102 may automatically select an available representative that is within geographic proximity of the member 110, shares a similar background as that of the member 110, and the like.

The representative 104 may be an individual that is assigned to the member 110 according to degrees or vectors of similarity between the member's and representative's demographic information. For instance, if the member 110 and the representative 104 share a similar background (e.g., attended university in the same city, are from the same hometown, share particular interests, etc.), the task facilitation service 102 may be more likely to assign the representative 104 to the member 110. Similarly, if the member 110 and the representative 104 are within geographic proximity to one another, the task facilitation service 102 may be more likely to assign the representative 104 to the member 110.

In an embodiment, the representative 104 can be an automated process, such as a bot, that may be configured to automatically engage and interact with the member 110. For instance, the task facilitation service 102 may utilize the responses provided by the member 110 during the onboarding process as input to a machine learning algorithm or artificial intelligence to generate a member profile and a bot that may serve as a representative 104 for the member 110. The bot may be configured to autonomously chat with the member 110 to generate tasks and proposals, perform tasks on behalf of the member 110 in accordance with any approved proposals, and the like as described herein. The bot may be configured according to the parameters or characteristics of the member 110 as defined in the member profile. As the bot communicates with the member 110 over time, the bot may be updated to improve the bot's interaction with the member 110.

When a representative 104 is assigned to the member 110 by the task facilitation service 102, the task facilitation service 102 may notify the member 110 and the representative 104 of the pairing. Further, the task facilitation service 102 may establish a chat session or other communications session between the member 110 and the assigned representative 104 to facilitate communications between the member 110 and the representative 104. For instance, via a web portal or an application provided by the task facilitation service 102 and installed on the computing device 112, the member 110 may exchange messages with the assigned representative 104 over the chat session or other communication session. Similarly, the representative 104 may be provided with an interface through which the representative may exchange messages with the member 110.

In an embodiment, the representative 104 can suggest one or more tasks based on member characteristics, task history, and other factors. For instance, as the member 110 communicates with the representative 104 over the communications session 116 and/or through any other communications session facilitated for different tasks and projects, the representative 104 may evaluate any messages 118 from the member 110 to identify any tasks that may be performed to reduce the member's cognitive load. As an illustrative example, if the member 110 indicates, over the communications session 116, that their spouse's birthday is coming up, the representative 104 may utilize their knowledge of the member 110 to develop one or more tasks that may be recommended to the member 110 in anticipation of their spouse's birthday. The representative 104 may recommend tasks such as purchasing a cake, ordering flowers, setting up a unique travel experience for the member 110, and the like. In some embodiments, the representative 104 can generate task suggestions without member input. For instance, as part of the onboarding process, the member 110 may provide the task facilitation service 102 with access to one or more member resources, such as the member's calendar, the member's personal fitness devices (e.g., fitness trackers, exercise equipment having communication capabilities, etc.), the member's vehicle data, and the like. Data collected from these member resources may be monitored by the representative 104, which may parse the data to generate task suggestions for the member 110.

In an embodiment, the task facilitation service 102, via a task recommendation system 106, can monitor the communications session 116 between the member 110 and the representative 104 in real-time and as messages are exchanged to identify any projects and/or tasks that the member 110 may wish to have performed by the representative 104 and/or one or more third-party services 114 for the member's benefit. The task recommendation system 106 may be implemented using a computer system or as an application or other executable code implemented on a computer system of the task facilitation service 102. In an embodiment, the task recommendation system 106 utilizes a machine learning algorithm, such as a natural language processing (NLP) algorithm, or other artificial intelligence to process, in real-time, these messages as they are exchanged between the member 110 and the representative 104 over the communications session 116 to identify possible projects and/or tasks that may be recommended to the member 110. For instance, the task recommendation system 106 may process any incoming messages 118 from the member 110 in real-time and as these incoming messages 118 are exchanged using NLP or other artificial intelligence to detect a new project and/or task that the member 110 would like to have resolved or otherwise performed for the benefit of the member 110.

The machine learning algorithm or other artificial intelligence may be dynamically trained using supervised training techniques. For instance, a dataset of input messages and corresponding projects and tasks (and corresponding parameters) can be selected for training of the machine learning algorithm or other artificial intelligence. The machine learning algorithm or artificial intelligence may be evaluated to determine, based on the sample inputs supplied to the machine learning algorithm or artificial intelligence, whether the machine learning algorithm or artificial intelligence is accurately identifying projects and tasks based on the supplied messages. Based on this evaluation, the machine learning algorithm or artificial intelligence may be modified to increase the likelihood of the machine learning algorithm or artificial intelligence to accurately identify projects and/or tasks corresponding to the sample messages provided as input. The machine learning algorithm or artificial intelligence may further be dynamically trained by soliciting feedback from members and representatives of the task facilitation service 102 with regard to the identification of projects and tasks based on communications sessions between these members and representatives. For instance, if the task recommendation system 106 determines that the machine learning algorithm or artificial intelligence has failed to identify projects and/or tasks that a member 110 would have liked to have completed to address an issue, the task recommendation system 106 may use this feedback, along with the corresponding messages submitted by the member 110 identifying the issue from which the project or task should have been created, to retrain the machine learning algorithm or artificial intelligence to better identify projects and/or tasks based on similar messages from members of the task facilitation service 102.

In an embodiment, the machine learning algorithm or other artificial intelligence can be dynamically trained in real-time as messages are exchanged between the member 110 and the representative 104 over the communications session 116. For example, if the machine learning algorithm or artificial intelligence fails to identify, based on messages exchanged by the member 110 over the communications session 116, a project or task that the member 110 would like to have performed to address an issue, and the member 110 at a later time transmits a message over the communications session 116 admonishing the representative 104 for failing to define a new task or project for the issue, the task recommendation system 106 may dynamically retrain the machine learning algorithm or artificial intelligence based on the feedback to increase the likelihood of the machine learning algorithm or artificial intelligence automatically identifying projects and/or tasks that may be performed from similar messages exchanges between members and representatives. Alternatively, if the machine learning algorithm or artificial intelligence has successfully identified, based on messages exchanges between the member 110 and the representative 104, a project or task that may be performed to address an issue, for which the member 110 has indicated that they are pleased with the identification of the project or task, the task recommendation system 106 may use the member's message indicating satisfaction with the identification of the project or task to dynamically reinforce the machine learning algorithm or artificial intelligence. This may increase the likelihood of the machine learning algorithm or artificial intelligence identifying similar projects or tasks based on similar communications exchanged between members and representatives.

In an embodiment, if the task recommendation system 106 identifies one or more projects and/or tasks that may be performed for the benefit of the member 110, the task recommendation system 106 can present these one or more projects and/or tasks to the representative 104 via a representative console provided to the representative 104 by the task facilitation service 102. The representative 104, based on their knowledge of the member 110, may select any of the identified one or more projects and/or tasks for presentation to the member 110. In some instances, if the representative 104 selects any of the identified one or more projects and/or tasks, the task recommendation system 106 may provide, via the representative console, one or more task templates that may be used to further define the selected projects and/or tasks. The one or more task templates may correspond to the task type or category for the projects and/or tasks being defined.

In an embodiment, the task facilitation service 102 may maintain a resource library that may serve as a repository for different project and task generation templates. These project and task generation templates may correspond to different project and task types or categories. For example, the task facilitation service 102 may maintain, within the resource library, a project generation template for projects related to member relocations to a new location. As another illustrative example, the task facilitation service 102 may maintain a project generation template for projects that may be related to event planning (e.g., birthday parties, anniversaries, etc.). As yet another illustrative example, the task facilitation service 102 may maintain a project generation template for projects that may be related to meal planning. The different project generation templates may include different data fields that may be used to define a particular project and corresponding tasks that may be completed for the benefit of the member 110. For example, a project generation template corresponding to member relocations may include data fields through which a representative 104 may define the member's current home size, the member's current utilities, any time restrictions or deadlines for the relocation, and the like.

In an embodiment, the task facilitation service 102 can automatically populate one or more data fields from a selected template based on information provided in the member profile associated with the member 110. For example, if the selected project generation template corresponds to a member relocation to a new location, the task facilitation service 102 may automatically populate any data fields within the template corresponding to the member's current home based on information within the member profile that indicates different parameters corresponding to the member's home (e.g., physical address, square footage, family composition, etc.). As another illustrative example, if the selected template corresponds to a project for planning a birthday party, the task facilitation service 102 may automatically process the member profile associated with the member 110 to determine any of the member's budget restrictions or preferences, any previously used venues for similar events (e.g., previously held birthday parties, etc.), the person for whom the birthday is being held based on family member birthdates, and the like. Based on this information, the task facilitation service 102 may automatically process the member profile associated with the member 110 to automatically populate any relevant data fields within the template for this particular event.

The representative 104, via a task template for a particular project or task, may define various parameters associated with the new project or task that is to be presented and performed for the benefit of the member 110. For instance, via a task template, the representative 104 may define an assignment of the task (e.g., to the representative 104, to a third-party service 114, to the member 110, etc.). In some instances, the task recommendation system 106 may use a machine learning algorithm or artificial intelligence to identify which data fields are to be presented in the task template to the representative 104 for creation of a new task or project. For example, the task recommendation system 106 may use, as input to the machine learning algorithm or artificial intelligence, a member profile associated with the member 110 and the selected task template for the new project or task. The task recommendation system 106 may indicate which data fields may be omitted from the task when presented to the member 110. Thus, the representative 104 may be required to provide all necessary information for a new task or project regardless of whether all information is presented to the member 110 or not.

The machine learning algorithm or artificial intelligence used to identify the data fields that are to be presented in the task template to the representative 104 for creation of a new task or project may be trained using unsupervised training techniques. For instance, a dataset of input member attributes and task/project attributes may be analyzed using a clustering algorithm to identify correlations between different types of members and tasks/projects. Example clustering algorithms that may be trained using sample member attributes and representative attributes (e.g., historical data, hypothetical data, etc.) to identify potential pairings may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of the machine learning algorithm or artificial intelligence generated using the member attributes and task/project attributes as input, the task recommendation system 106 may identify the data fields that are to be presented in the task template for the new project or task.

In an embodiment, the task recommendation system 106 can automatically generate a project and/or task without need for the representative 104 to interact with a corresponding task template to further define the project and/or task. For instance, the task recommendation system 106 can use, in real-time, the member's messages 118, member-specific data from the member profile (e.g., characteristics, demographics, location, historical responses to recommendations and proposals, etc.), data corresponding to similarly-situated members, and historical data corresponding to tasks previously performed for the benefit of the member 110 and the other similarly-situated members as input to a machine learning algorithm or artificial intelligence to generate a new project and/or task that may be recommended to the member 110. For instance, if the member 110 has indicated, via the communications session 116 with the representative 104, that the member 110 needs assistance with repairing their gutters, the task recommendation system 106 can use the messages 118 corresponding to this request for assistance, as well as the other aforementioned data, as input to the machine learning algorithm or artificial intelligence to generate a new task for the member 110 corresponding to the needed repair.

The machine learning algorithm or artificial intelligence used to automatically generate new projects and/or tasks for members of the task facilitation service 102 may be trained using supervised training techniques. For instance, a dataset of input messages, corresponding member profiles of the provider of the messages and of similarly-situated members, and historical data corresponding to previously performed tasks/projects can be selected for training of the machine learning algorithm or other artificial intelligence. The machine learning algorithm or artificial intelligence may be evaluated to determine, based on the sample inputs supplied to the machine learning algorithm or artificial intelligence, whether the machine learning algorithm or artificial intelligence is accurately identifying and generating projects and tasks based on the supplied messages and identification of similarly-situated members. Based on this evaluation, the machine learning algorithm or artificial intelligence may be modified to increase the likelihood of the machine learning algorithm or artificial intelligence to accurate identify and generate projects and/or tasks corresponding to the provided input. The machine learning algorithm or artificial intelligence may further be dynamically trained by soliciting feedback from members and representatives of the task facilitation service 102 with regard to the identification and automatic generation of projects and tasks based on communications sessions between these members and representatives, as described above.

In some instances, the task recommendation system 106, utilizing the machine learning algorithm or artificial intelligence may identify similar tasks performed for other members of the task facilitation service 102 that may be used to generate the new task for the member 110. Using the aforementioned example of a member request for assistance with repairing their gutters, the task recommendation system 106 may identify any previously performed tasks for members within the member's 110 geographic area (e.g., same neighborhood, same city, same state, etc.) related to gutter repairs. Further, the task recommendation system 106 may evaluate member profiles of such members within the member's 110 geographic area to identify any similarly-situated members (e.g., members with similar preferences, members with similar characteristics, etc.). If the task recommendation system 106 identifies similar tasks previously performed for similarly-situated members of the task facilitation service 102, the task recommendation system 106 may utilize these similar tasks to automatically generate a new task for the member 110. For example, the task recommendation system 106, for the new task, may use a similar task description, select the same or similar third-party services 114 for performance of the task, provide an estimated budget for completion of the task, define a priority for the task, assign an estimated deadline or time for completion of the task, and the like.

In an embodiment, if the task recommendation system 106 automatically generates one or more new projects and/or tasks for the member 110 based on the messages 118 submitted by the member 110 over the communications session 116, the task recommendation system 106 provides the one or more new projects and/or tasks to the representative 104 to allow the representative 104 to evaluate the one or more new projects and/or tasks and determine which projects and/or tasks to present to the member 110. For instance, a listing of the one or more projects and/or tasks that may be recommended to the member 110 may be provided to the representative 104 for a final determination as to which projects and/or tasks may be presented to the member 110 via the communications session 116 and/or through a project interface 122 provided to the member 110. In an embodiment, the task recommendation system 106 can rank the new projects and/or tasks based on a likelihood of the member 110 selecting the project and/or task for delegation to the representative 104 for performance and/or coordination with third-party services 114. Alternatively, the task recommendation system 106 may rank the projects and/or tasks based on the level of urgency for completion of each project and/or task. The level of urgency may be determined based on member characteristics (e.g., data corresponding to a member's own prioritization of certain tasks or categories of tasks) and/or potential risks to the member 110 if the project and/or task is not performed. For example, a task corresponding to replacement or installation of carbon monoxide detectors within the member's home may be ranked higher than a task corresponding to the replacement of a refrigerator water dispenser filter, as carbon monoxide filters may be more critical to member safety. As another illustrative example, if a member 110 places significant importance on the maintenance of their vehicle, the task recommendation system 106 may rank a task related to vehicle maintenance higher than a task related to other types of maintenance. As yet another illustrative example, the task recommendation system 106 may rank a task related to an upcoming birthday higher than a task that can be completed after the upcoming birthday.

If the task recommendation system 106 automatically generates one or more new projects and/or tasks for the member 110 based on the messages 118 submitted by the member 110 over the communications session 116, the task recommendation system 106, in an embodiment, automatically generates a specific communications session for each new project and/or task. This specific communications session corresponding to a particular project or task may be distinct from the communications session 116 previously established between the member 110 and the representative 104. Through this project- or task-specific communications session, the member 110 and the representative 104 may exchange messages related to the particular project or task. For example, through this project- or task-specific communications session, the representative 104 may prompt the member 110 for information that may be required to determine one or more parameters of the project or task. Similarly, if the member 110 has questions related to the particular project or task, the member 110 may provide these questions through the project- or task-specific communications session. The implementation of project- or task-specific communications sessions may reduce the number of messages exchanged through other chat or communications sessions while ensuring that communications within these project- or task-specific communications sessions are relevant to the corresponding projects or tasks.

In an embodiment, the task recommendation system 106 can automatically determine whether additional information is required from the member 110 for the creation of a new project or task. For instance, the task recommendation system 106 may process the generated project and/or task and information corresponding to the member 110 using a machine learning algorithm or artificial intelligence to automatically identify additional parameters for the task, as well as any additional information that may be required from the member 110 for the generation of proposals. For instance, the task recommendation system 106 may use the generated project or task, information corresponding to the member 110 (such as from the member profile), and historical data corresponding to projects and/or tasks performed for other similarly-situated members as input to the machine learning algorithm or artificial intelligence to identify any additional information that may be required of the member 110 for defining the project and/or task. If the task recommendation system 106 determines that additional member input is required for the project or task, the task recommendation system 106 may provide the representative 104 with recommendations for questions that may be presented to the member 110 regarding the project or task. Returning to the “Move to Bayamon” project 124 example illustrated in FIG. 1, if the task recommendation system 106 determines that it is important to understand one or more parameters of the member's home (e.g., square footage, number of rooms, etc.) for the project, the task recommendation system 106 may provide a recommendation to the representative 104 to prompt the member 110 to provide these one or more parameters. The representative 104 may review the recommendations provided by the task recommendation system 106 and, via a communications session corresponding to the particular project, prompt the member 110 to provide the additional project parameters. This process may reduce the number of prompts provided to the member 110 in order to define a particular project or task, thereby reducing the cognitive load on the member 110. In some instances, rather than providing the representative with recommendations for questions that may be presented to the member 110 regarding the project or task, the task recommendation system 106 can automatically present these questions to the member 110 via a communications session specific to the project or task. For instance, if the task recommendation system 106 determines that a question related to the square footage of the member's home is required for the project 124, the task recommendation system 106 may automatically prompt the member 110, via a new communications session corresponding to the project 124, to provide the square footage for the member's home.

In an embodiment, the task recommendation system 106 can further provide the representative 104 with recommendations for questions that may be presented to the member 110 regarding the project or task based on the member's preferences. For example, if the member 110 is known to be budget conscious, and the representative 104 and/or the task recommendation system 106 has not defined any budgets or budget restrictions for the task or project, the task recommendation system 106 may prompt the representative 104 to communicate with the member 110 via a communications session corresponding to the task or project to inquire about the member's budget for completion of the project or task. In an embodiment, the task recommendation system 106 can use a machine learning algorithm or artificial intelligence to determine what questions may be provided to the member 110. For instance, the task recommendation system 106 may use the parameters defined for the new project or task, the member's profile, and historical data corresponding to projects and/or tasks previously performed for the benefit of the member 110 as input to the machine learning algorithm or artificial intelligence to determine the member's preferences and to identify questions that may be provided to the member 110 based on these preferences to further define the parameters of the new project or task.

In an embodiment, once the representative 104 has obtained the necessary task and/or project-related information from the member 110 and/or through the task recommendation system 106 (e.g., task parameters garnered via evaluation of tasks performed for similarly situated members, etc.), the representative can utilize a task coordination system 108 of the task facilitation service 102 to generate one or more proposals for resolution of the project and/or task. The task coordination system 108 may be implemented using a computer system or as an application or other executable code implemented on a computer system of the task facilitation service 102. In some examples, the representative 104 may utilize a resource library maintained by the task coordination system 108 to identify one or more third-party services 114 and/or resources (e.g., retailers, restaurants, websites, brands, types of goods, particular goods, etc.) that may be used for performance of the project and/or task for the benefit of the member 110 according to the one or more parameters identified by the representative 104 and the task recommendation system 106, as described above. A proposal may specify a timeframe for completion of the project and/or task, identification of any third-party services 114 (if any) that are to be engaged for completion of the project and/or task, a budget estimate for completion of the project and/or task, resources or types of resources to be used for completion of the project and/or task, and the like. The representative 104 may present the proposal to the member 110 via the communications session corresponding to the task or project to solicit a response from the member 110 to either proceed with the proposal or to provide an alternative proposal for completion of the project and/or task.

Once a member 110 has selected a particular proposal option for a particular project or task, the new project and any corresponding tasks are presented to the member 110 via a project interface 122, through which the member 110 can review the project 124 corresponding to the stated issue and the tasks 126 corresponding to the selected proposal option from the proposal for the particular project 124. Through the project interface 122, the member 110 may review a description of the project 124 that is to be performed for the benefit of the member 110, as well as details regarding the corresponding tasks 126 that are to be performed in order to complete the project 124. For example, as illustrated in FIG. 1, the representative 104 or the task recommendation system 106 may update the project interface 122 to present the new project 124 related to the member's upcoming move to Bayamon and one or more tasks 126 corresponding to the project 124. The number of tasks 126 presented via the project interface 122 and the details provided for these tasks 126 and the project 124 itself may be determined based on the member's preferences or attributes specified in the member's profile. For instance, the amount of detail provided and the number of tasks 126 presented may be determined such that the member 110 is adequately informed with regard to the project 124 and corresponding tasks 126 while considering the member's cognitive load (e.g., the presentation of information does not add stress to the member 110, thereby maintaining the member's cognitive load). Additionally, through the project interface 122, the member 110 may access any project and/or task-specific communications sessions, through which the member 110 may communicate with the representative 104 with regard to any tasks 126 associated with the project 124 and to the project 124 itself.

In some instances, the representative 104 may coordinate with one or more third-party services 114 for completion of the project or task for the benefit of the member 110. For instance, the representative 104 may utilize a task coordination system 108 of the task facilitation service 102 to identify and contact one or more third-party services 114 for performance of a project or task. As noted above, the task coordination system 108 may include a resource library that includes detailed information related to third-party services 114. For example, an entry for a third-party service in the resource library may include contact information for the third-party service, any available price sheets for services or goods offered by the third-party service, listings of goods and/or services offered by the third-party service, hours of operation, ratings or scores according to different categories of members, and the like. The representative 104 may query the resource library to identify the one or more third-party services 114 that are to perform the project or task and determine an estimated cost for performance of the project or task. In some instances, the representative 104 may contact the one or more third-party services 114 to obtain quotes for completion of the task and to coordinate performance of the project or task for the benefit of the member 110.

In some instances, the resource library may further include detailed information corresponding to other services and other entities that may be associated or affiliated with the task facilitation service 102 and that are contracted to perform various project and/or tasks on behalf of members of the task facilitation service 102. These other services and other entities may provide their services or goods at rates agreed upon with the task facilitation service 102. Thus, if the representative 104 selects any of these other services or other entities from the resource library, the representative 104 may be able to determine the particular parameters (e.g., price, availability, time required, etc.) for completion of the project and any associated tasks.

In an embodiment, for a given project or task, the representative 104 can query the resource library to identify one or more third-party services 114 and other services/entities affiliated with the task facilitation service 102 from which to solicit quotes for completion of the project or task. For instance, for a newly created task, the representative 104 may transmit a job offer to these one or more third-party services 114 and other services/entities. The job offer may indicate various characteristics of the task that is to be completed (e.g., scope of the task, general geographic location of the member 110 or of where the task is to be completed, desired budget, etc.). Through an application or web portal provided by the task facilitation service 102, a third-party service or other service/entity may review the job offer and determine whether to submit a quote for completion of the task or to decline the job offer. If a third-party service or other service/entity opts to reject the job offer, the representative may receive a notification indicating that the third-party service or other service/entity has declined the job offer. Alternatively, if a third-party service or other service/entity opts to bid to perform the task (e.g., accepts the job offer), the third-party service or other service/entity may submit a quote for completion of the task. This quote may indicate the estimated cost for completion of the task, the time required for completion of the task, the estimated date in which the third-party service or other service/entity is available to begin performance of the task, and the like.

The representative 104 may use any provided quotes from the third-party services 114 and/or other services/entities to generate different proposals for completion of the project or task. These different proposals may be presented to the member 110 through the project- or task-specific interface corresponding to the particular project or task that is to be completed. If the member 110 selects a particular proposal from the set of proposals presented through the project- or task-specific interface, the representative 104 may transmit a notification to the third-party service or other service/entity that submitted the quote associated with the selected proposal to indicate that it has been selected for completion of the project or task. Accordingly, the representative 104 may utilize the task coordination system 108 to coordinate with the third-party service or other service/entity for completion of the project or task.

In some instances, if the project or task is to be completed by the representative 104, the representative 104 may utilize the task coordination system 108 to identify any resources that may be utilized by the representative 104 for performance of the project or task. The resource library may include detailed information related to different resources available for performance of a project or task. As an illustrative example, if the representative 104 is tasked with purchasing a set of filters for the member's home, the representative 104 may query the resource library to identify a retailer that may sell filters of a quality and/or price that is acceptable to the member 110 and that corresponds to the proposal option accepted by the member 110. Further, the representative 104 may obtain available payment information of the member 110 that may be used to provide payment for any resources required by the representative 104 to complete the project or task. Using the aforementioned example, the representative 104 may obtain payment information of the member 110 from the member's profile to complete a purchase with the retailer for the set of filters that are to be used in the member's home.

If the representative 104 is able to coordinate with one or more third-party services 114 for performance of the project or task (e.g., schedule a time for performance of the project or task, agree upon a price for performance of the project or task, etc.), the representative 104 may update the project interface 122 to indicate when the project 124 and any associated tasks 126 are expected to be completed and the estimated cost for completion of the project 124 and the associated tasks 126. If any of the information provided in the update does not correspond to the estimates provided in the selected proposal option, the member 110 may be provided with an option to cancel the project 124 or particular task 126, or otherwise make changes to the project 124 or particular task 126. For instance, if the estimated cost for performance of a task 126 exceeds the maximum amount specified in the selected proposal option, the member 110 may ask the representative 104 to find an alternative third-party service 114 for performance of the task 126 within the budget specified in the selected proposal option. Similarly, if the timeframe for completion of the task 126 is not within the timeframe indicated in the selected proposal option, the member 110 can ask the representative 104 to find an alternative third-party service 114 for performance of the task 126 within the original timeframe. The member's interventions may be recorded by the task recommendation system 106 and the task coordination system 108 to retrain their corresponding machine learning algorithms or artificial intelligence to define more accurate proposal option parameters for the member 110 and to better identify third-party services 114 that may perform tasks within the defined proposal option parameters, respectively.

In an embodiment, once the representative 104 has contracted with one or more third-party services 114 for performance of a project or task, the task coordination system 108 may monitor performance of the project or task by these third-party services 114. For instance, the task coordination system 108 may record any information provided by the third-party services 114 with regard to the timeframe for performance of the project or task, the cost associated with performance of the project or task, any status updates with regard to performance of the project or task, and the like. Status updates provided by third-party services 114 may be provided automatically to the member 110 via the project interface 122 provided by the task facilitation service 102. Additionally, or alternatively, these status updates may be provided automatically to the representative 104 via a representative console.

In an embodiment, if the task is to be performed by the representative 104, the task coordination system 108 can monitor performance of the project or task by the representative 104. For instance, the task coordination system 108 may monitor, in real-time, any communications between the representative 104 and the member 110 regarding the representative's performance of the project or task. These communications may include messages from the representative 104 over the communications session corresponding to the project or to the particular task being performed as part of the project indicating any status updates with regard to performance of the project or task, any purchases or expenses incurred by the representative 104 in performing the project or task, the timeframe for completion of the project or task, and the like. The task coordination system 108 may further use these messages from the representative 104 to automatically update the project interface 122 to provide the member 110 with updates related to the performance of the project 124 and any corresponding tasks 126.

Once a task or the corresponding project has been completed, the member 110 may be prompted to provide feedback with regard to completion of the project or task. For instance, the member 110 may be prompted to provide feedback with regard to the performance and professionalism of the selected third-party services 114 in performance of the project or task. Further, the member 110 may be prompted to provide feedback with regard to the quality of the proposal options provided by the representative 104 and as to whether the performance of the project or task has addressed the underlying issue associated with the project or task. Using the responses provided by the member 110, the task facilitation service 102 may train or otherwise update the machine learning algorithms or artificial intelligence utilized by the task recommendation system 106 and the task coordination system 108 to provide better identification of projects and tasks, creation of proposals and corresponding proposal options, identification of third-party services 114 for completion of projects and tasks for the benefit of the member 110 and other similarly-situated members, identification of resources that may be provided to the representative 104 for performance of a project or task for the benefit of the member 110, and the like.

It should be noted that for the processes described herein, various operations performed by the representative 104 may be additionally, or alternatively, performed using one or more machine learning algorithms or artificial intelligence. For example, as the representative 104 performs or otherwise coordinates performance of projects and tasks on behalf of a member 110 over time, the task facilitation service 102 may continuously and automatically update the member's profile according to member feedback related to the performance of these projects and tasks by the representative 104 and/or third-party services 114. In an embodiment, the task recommendation system 106, after a member's profile has been updated over a period of time (e.g., six months, a year, etc.) or over a set of projects and tasks (e.g., twenty tasks, thirty tasks, etc.), may utilize a machine learning algorithm or artificial intelligence to automatically and dynamically generate new projects and tasks based on the various attributes of the member's profile (e.g., historical data corresponding to member-representative communications, member feedback corresponding to representative performance and presented tasks/proposals, etc.) with or without representative 104 interaction. The task recommendation system 106 may automatically communicate with the member 110 to obtain any additional information required for new projects and tasks and automatically generate proposals that may be presented to the member 110 for performance of these projects and tasks. The representative 104 may monitor communications between the task recommendation system 106 and the member 110 to ensure that the conversation maintains a positive polarity (e.g., the member 110 is satisfied with its interaction with the task recommendation system 106 or other bot, etc.). If the representative 104 determines that the conversation has a negative polarity (e.g., the member 110 is expressing frustration, the task recommendation system 106 or bot is unable to process the member's responses or asks, etc.), the representative 104 may intervene in the conversation. This may allow the representative 104 to address any member concerns and perform any projects and tasks on behalf of the member 110.

Thus, unlike automated customer service systems and environments, wherein these systems and environment may have little to no knowledge of the users interacting with agents or other automated systems, the task recommendation system 106 can continuously update the member profile to provide up-to-date historical information about the member 110 based on the member's automatic interaction with the system or interaction with the representative 104 and on the projects and tasks performed on behalf of the member 110 over time. This historical information, which may be automatically and dynamically updated as the member 110 or the system interacts with the representative 104 and as projects and tasks are devised, proposed, and performed for the member 110 over time, may be used by the task recommendation system 106 to anticipate, identify, and present appropriate or intelligent responses to member 110 queries, needs, and/or goals.

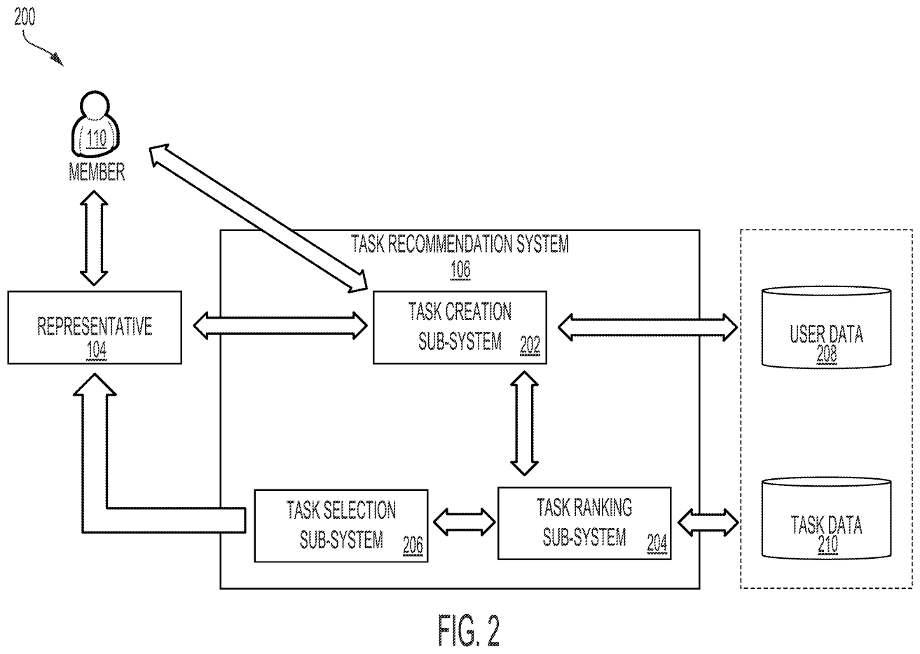

FIG. 2 shows an illustrative example of an environment 200 in which a task recommendation system 106 generates and ranks recommendations for different projects and/or tasks that can be presented to a member 110 in accordance with at least one embodiment. In the environment 200, a member 110 and/or representative 104 interacts with a task creation sub-system 202 of the task recommendation system 106 to generate a new task or project that can be performed for the benefit of the member 110. The task creation sub-system 202 may be implemented using a computer system or as an application or other executable code implemented on a computer system of the task recommendation system 106.

In an embodiment, a member 110 can access the task creation sub-system 202 to manually generate a new task or project that may be assigned to a representative 104 and/or one or more third-party services for performance of the new task or project for the benefit of the member 110. For instance, a member 110 may explicitly indicate to the representative 104 that they require assistance with regard to a particular issue. As an illustrative example, the member 110 may indicate, in a message to the representative 104 over a communications session, that they would like assistance with an upcoming move to a new town. The representative 104 may evaluate this message and determine that the member 110 has defined an issue for which a project and corresponding tasks may be generated to address the issue. Alternatively, the member 110 may directly access the task creation sub-system 202 to request creation of a project corresponding to a particular issue that the member 110 would like assistance with. For instance, the task facilitation service may provide, via an application or web portal of the task facilitation service, an option for manual entry of a project or task that may be delegated to the representative 104 or that may otherwise be added to the member's list of projects and tasks.

If the member 110 selects an option for manual entry of a project or task, the task facilitation service may provide, via an interface of the application or web portal, a project or task template through which the member may enter various details related to the project or task. The project or task template may include various fields through which the member 110 may provide a name for the project or task, a description of the project or task (e.g., “I need to have my gutters cleaned before the upcoming storm,” “I'd like to have painters touch up my powder room,” etc.), a timeframe for performance of the project or task (e.g., a specific deadline date, a date range, a level of urgency, etc.), a budget for performance of the project or task (e.g., no budget limitation, a specific maximum amount, etc.), and the like.

In some instances, if the member 110 selects an option for manual entry of a project or task, the task facilitation service may provide the member 110 with different project and task templates that may be used to generate a new project or task. As noted above, the task facilitation service may maintain a resource library that serves as a repository for different project and task templates corresponding to different project and task categories (e.g., vehicle maintenance tasks, home maintenance tasks, family-related event tasks, care giving tasks, experience-related tasks, etc.). A project or task template may include a plurality of project or task definition fields that may be used to define a project or task that may be performed for the benefit of the member 110. For example, the task definition fields corresponding to a vehicle maintenance task may be used to define the make and model of the member's vehicle, the age of the vehicle, information corresponding to the last time the vehicle was maintained, any reported accidents associated with the vehicle, a description of any issues associated with the vehicle, and the like. Thus, each template maintained in the resource library may include fields that are specific to the project or task category associated with the template.

In an embodiment, the task creation sub-system 202 can monitor, automatically and in real-time, messages as they are exchanged between the member 110 and the representative 104 over a communications session to identify a project or task that can be performed for the benefit of the member 110 in order to address an issue specified by the member 110 over the communications session. For instance, the task creation sub-system 202 may process messages between the member 110 and the representative 104 in real-time and as these messages are being exchanged using a machine learning algorithm or artificial intelligence to automatically identify any projects and/or tasks for which the representative 104 and the task facilitation service may provide assistance to the member 110 for addressing a stated issue. The task creation sub-system 202 may utilize NLP or other artificial intelligence to evaluate these exchanged messages or other communications from the member 110 in real-time to identify any projects and/or tasks that may be performed in order to address an issue expressed by the member 110. In some instances, the task creation sub-system 202 may utilize historical data corresponding to previously identified projects and tasks for similarly situated members and corresponding messages from these members from a user datastore 208 to train the NLP or other artificial intelligence to identify possible projects and tasks. If the task creation sub-system 202 identifies one or more projects and/or tasks that may be performed to address a specified issue, the task creation sub-system 202 may present these projects and/or tasks to the representative 104.

In an embodiment, if the task creation sub-system 202 identifies a project or task that may be performed in order to address an issue expressed by the member 110, the task creation sub-system 202 automatically facilitates a communications session that is specific to the identified project or task. This communications session may differ from the original communications session facilitated by the task facilitation service and between the member 110 and the representative 104. This project or task-specific communications session may be presented through an interface that is specific to the identified project or task. For example, if the task creation sub-system 202 identifies a project or task that may be performed in order to address an issue expressed by the member 110, the task creation sub-system 202 may automatically generate a new interface corresponding to this identified project or task. This new interface may be presented to the member 110 through the application or web portal provided by the task facilitation service. Through this interface, the task creation sub-system 202 may facilitate a communications session between the member 110 and the representative 104, through which the member 110 and the representative 104 may exchange communications corresponding to the identified project or task.

In an embodiment, the task creation sub-system 202 provides, for each identified project and/or task, a template through which the representative 104 may define various parameters for the project and/or task. For instance, the task creation sub-system 202 may provide various task templates that may be used by the representative 104 to further define a project and/or task identified by the task creation sub-system 202. The task creation sub-system 202 may maintain, in a task datastore 210, task templates for different project and task types or categories. Each task template may include different data fields for defining the project or task, whereby the different task fields may correspond to the project or task type or category for the project or task being defined. The representative 104 may provide project or task information via these different data fields to define the project or task that may be submitted to the task creation sub-system 202 for processing.

In an embodiment, the data fields presented in a template for a project or task can be selected based on a determination generated using a machine learning algorithm or artificial intelligence. For example, the task creation sub-system 202 can use, as input to the machine learning algorithm or artificial intelligence, a member profile from the user datastore 208 and the selected template from the task datastore 210 to identify which data fields may be omitted from the template when presented to the representative 104 for definition of a new task or project. For instance, if the member 110 is known to delegate maintenance tasks to a representative 104 and is indifferent to budget considerations, the task creation sub-system 202 may present, to the representative 104, a task template that omits any budget-related data fields and other data fields that may define, with particularity, instructions for completion of the task. In some instances, the task creation sub-system 202 may allow the representative 104 to add, remove, and/or modify the data fields for the template. For example, if the task creation sub-system 202 removes a data field corresponding to the budget for the task based on an evaluation of the member profile, the representative 104 may request to have the data field added to the template to allow the representative 104 to define a budget for the task based on its knowledge of the member 110. The task creation sub-system 202, in some instances, may utilize this change to the template to retrain the machine learning algorithm or artificial intelligence to improve the likelihood of providing templates to the representative 104 without need for the representative 104 to make any modifications to the template for defining a new project or task.

In an embodiment, the task creation sub-system 202 can automatically populate the data fields presented in a template based on parameters of the new project or task as identified from member messages exchanged over the communications session corresponding to the new project or task and/or the original communications session through which the member 110 communicated their request or desire for the representative 104 to assist the member 110 in addressing an issue. For instance, the task creation sub-system 202 may use NLP or other artificial intelligence to evaluate messages or other communications from the member 110 exchanged over these communications sessions in real-time to identify various parameters for the new project or task as these messages are exchanged. As an illustrative example, if the member 110 states, in a message to the representative 104, that they do not want to spend over $500 to address an identified issue, the task creation sub-system 202, using NLP or other artificial intelligence, may determine that the budget cap for the new project or task is $500 and input this value into the corresponding data field for the project or task. This may reduce the burden on the representative 104 to provide the required information for the new project or task.

In an embodiment, the task creation sub-system 202 can further provide, to the representative 104, recommendations for questions that may be presented to the member 110 regarding the project or task based on the member's preferences. For example, if the representative 104 has not defined any budgets or budget restrictions for a new task or project, and the task creation sub-system 202 determines that the member 110 is budget conscious, the task creation sub-system 202 may prompt the representative 104 to communicate with the member 110 via the communications session corresponding to the new task or project to inquire about the member's budget for completion of the project or task. In an embodiment, the task creation sub-system 202 can use a machine learning algorithm or artificial intelligence to determine what questions may be provided to the member 110. For instance, the task creation sub-system 202 may use the parameters defined for the new project or task, the member's profile, and historical data corresponding to projects and/or tasks previously performed for the benefit of the member 110 as input to the machine learning algorithm or artificial intelligence to determine the member's preferences and to identify questions that may be provided to the member 110 based on these preferences to further define the parameters of the new project or task.

The task recommendation system 106 may further include a task ranking sub-system 204, which may be configured to rank the tasks and/or projects associated with a member 110, including tasks and/or projects that may be recommended to the member 110 for completion by the member 110, the representative 104, or other third-party services and/or other services/entities associated with the task facilitation service. The task ranking sub-system 204 may be implemented using a computer system or as an application or other executable code implemented on a computer system of the task recommendation system 106. In an embodiment, the task ranking sub-system 204 can rank the member's projects and/or tasks based on a likelihood of the member 110 selecting the project or task for delegation to the representative 104 for performance and coordination with third-party services. Alternatively, the task ranking sub-system 204 may rank the member's projects and/or tasks based on the level of urgency for completion of each project or task. The level of urgency may be determined based on member characteristics from the user datastore 208 (e.g., data corresponding to a member's own prioritization of certain projects/tasks or categories of projects/tasks) and/or potential risks to the member 110 if the project or task is not performed.

In an embodiment, the task ranking sub-system 204 provides the ranked list of the projects and/or tasks that may be recommended to the member 110 to a task selection sub-system 206. The task selection sub-system 206 may be implemented using a computer system or as an application or other executable code implemented on a computer system of the task recommendation system 106. The task selection sub-system 206 may be configured to select, from the ranked list of the projects and/or tasks, which projects and/or tasks may be recommended to the member 110 by the representative 104. For instance, if the application or web portal provided by the task facilitation service is configured to present, to the member 110, a limited number of task and/or project recommendations from the ranked list of the projects and/or tasks, the task selection sub-system 206 may process the ranked list and the member's profile from the user datastore 208 to determine which project and/or task recommendations should be presented to the member 110. In some instances, the selection made by the task selection sub-system 206 may correspond to the ranking of the projects and/or tasks in the list. Alternatively, the task selection sub-system 206 may process the ranked list, as well as the member's profile and the member's existing projects and tasks (e.g., projects and tasks in progress, projects and tasks accepted by the member 110, etc.), to determine which projects and/or tasks may be recommended to the member 110. For instance, if the ranked list includes a task corresponding to gutter cleaning but the member 110 already has a task in progress corresponding to gutter repairs due to a recent storm, the task selection sub-system 206 may forego selection of the task corresponding to gutter cleaning, as this may be performed in conjunction with the gutter repairs. Thus, the task selection sub-system 206 may provide another layer to further refine the ranked list of the projects and/or tasks for presentation to the member 110.

The task selection sub-system 206 may provide, to the representative 104, a new listing of projects and/or tasks that may be recommended to the member 110. The representative 104 may review this new listing of projects and/or tasks to determine which projects and/or tasks may be presented to the member 110 via the project interface provided by the task facilitation service (as illustrated herein at FIG. 1). For instance, the representative 104 may review the set of projects and/or tasks recommended by the task selection sub-system 206 and select one or more of these projects and/or tasks for presentation to the member 110 via individual interfaces corresponding to these one or more projects and/or tasks. In some instances, the one or more projects and/or tasks may be presented to the member 110 according to the ranking generated by the task ranking sub-system 204 and refined by the task selection sub-system 206. Alternatively, the one or more projects and/or tasks may be presented according to the representative's understanding of the member's own preferences for project and task prioritization. Through the project interface, the member 110 may select one or more projects and/or tasks that may be performed with the assistance of the representative 104 or third-party services. The member 110 may alternatively dismiss any presented projects and/or tasks that the member 110 would rather perform personally or that the member 110 does not otherwise want performed.

In an embodiment, the task selection sub-system 206 monitors the different interfaces corresponding to the recommended projects and/or tasks, including any corresponding communications sessions between the member 110 and the representative 104, to collect data with regard to member selection of projects and/or tasks for delegation to the representative 104 or third-party services for performance. For instance, the task selection sub-system 206 may process messages corresponding to projects and/or tasks presented to the member 110 by the representative 104 over the different interfaces corresponding to the recommended projects and/or tasks to determine a polarity or sentiment corresponding to each project and/or task. For example, if a member 110 indicates, in a message to the representative 104, that they would prefer not to receive any task or project recommendations corresponding to vehicle maintenance, the task selection sub-system 206 may ascribe a negative polarity or sentiment to projects and tasks corresponding to vehicle maintenance. Alternatively, if a member 110 selects a task or project related to gutter cleaning for delegation to the representative 104 and/or indicates in a message to the representative 104 that recommendation of this task or project was a great idea, the task selection sub-system 206 may ascribe a positive polarity or sentiment to this task or project. In an embodiment, the task selection sub-system 206 can use these responses to tasks and/or projects recommended to the member 110 to further train or reinforce the machine learning algorithm or artificial intelligence utilized by the task ranking sub-system 204 to generate project and task recommendations that can be presented to the member 110 and other similarly situated members of the task facilitation service. Further, the task selection sub-system 206 may update the member's profile or model to update the member's preferences and known behavior characteristics based on the member's selection of projects and/or tasks from those recommended by the representative 104 and/or sentiment with regard to the projects and/or tasks recommended by the representative 104.

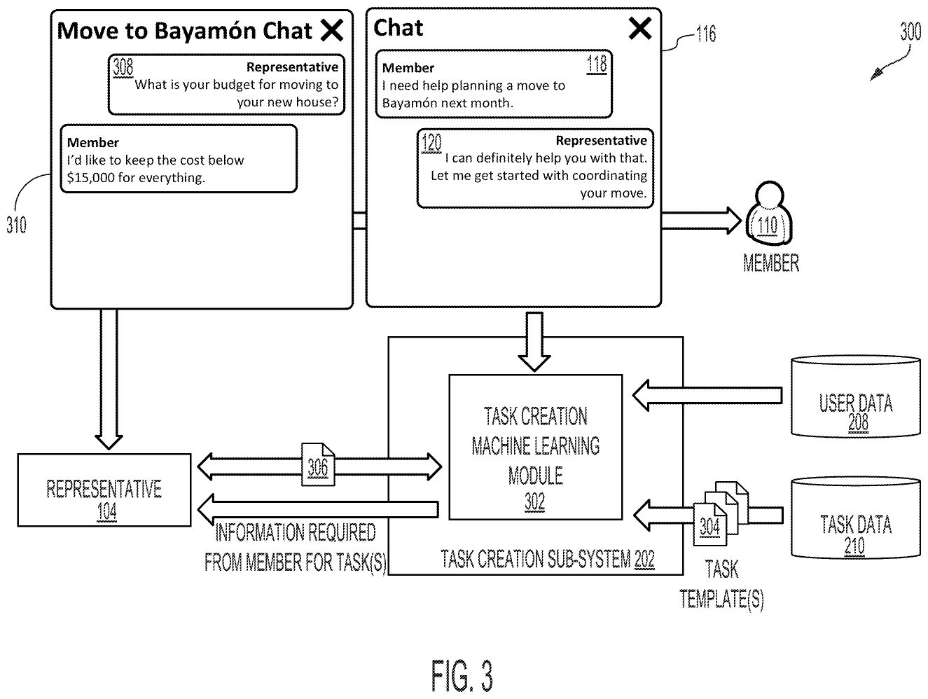

FIG. 3 shows an illustrative example of an environment 300 in which a machine learning algorithm or artificial intelligence is implemented to assist in the identification and creation of new projects and tasks in accordance with at least one embodiment. In the environment 300, the task creation sub-system 202 can include a task creation machine learning module 302 that can automatically, and in real-time, process messages 118, 120 exchanged between a member 110 and an assigned representative 104 as these messages 118, 120 are exchanged over a communications session 116 to identify any new tasks or projects that may be performed for the benefit of the member 110. The task creation machine learning module 302 may be implemented using a computer system or as an application or other executable code implemented on a computer system of the task recommendation system 106 for the task creation sub-system 202, as described above. Thus, the task creation machine learning module 302 may serve as a component or other functionality of the task creation sub-system 202.

In an embodiment, the task creation machine learning module 302 implements one or more machine learning algorithms or artificial intelligence to detect one or more possible projects and/or tasks based on messages 118, 120 exchanged over the communications session 116 and to further generate these projects and/or tasks automatically. For instance, the task creation machine learning module 302 may utilize NLP or other artificial intelligence to evaluate, in real-time, these exchanged messages 118, 120 to identify any projects and/or tasks that may be performed in order to address an issue expressed by the member 110. For example, as illustrated in FIG. 3, the member 110, in a message 118 to the representative 104, has indicated that they require assistance with an upcoming move to a new city (e.g., Bayamon). The task creation machine learning module 302, using NLP or other artificial intelligence, may process this message 118 in real-time to identify a new project corresponding to the upcoming move. Further, based on this message 118, the task creation machine learning module 302 may identify any corresponding parameters for the new project or task, such as timeframes or deadlines for completing the move, any budgetary constraints defined by the member 110 in the one or more messages to the representative 104 over the communications session 116, and any other information that may be useful for defining the new project and any corresponding tasks (e.g., square footage of the member's home, preferred vendors or other third-party services, etc.).

As noted above, the task creation sub-system 202 may utilize historical data corresponding to previously identified projects and tasks for similarly situated members and corresponding messages from these members from a user datastore 208 to train the NLP or other artificial intelligence used by the task creation machine learning module 302 to identify possible projects and tasks that may be performed for the benefit of the member 110. If the task creation machine learning module 302 identifies one or more projects and/or tasks that may be performed to address a specified issue, the task creation machine learning module 302 may present these projects and/or tasks to the representative 104, which may communicate with the member 110 over the communications session 116 to indicate that they have identified these projects and/or tasks and that they will accordingly assist the member 110 in addressing the member's specified issue.

In an embodiment, the task creation machine learning module 302 obtains, from a task datastore 210, one or more task templates 304 that may be used to define a new project and/or task(s) that may be assigned to the representative 104, member 110, and/or one or more third-party services in order to address an issue expressed by the member 110 or otherwise identified via messages 118 and other communications submitted via the communications session 116. A task template 304 may correspond to a particular project or task type. For instance, each task template 304 may include different data fields for defining the project or task, whereby the different task fields may correspond to the project or task type or category for the project or task being defined. The representative 104 may provide project or task information via these different data fields to define the project or task that may be submitted to the task creation sub-system 202 for processing.

In an embodiment, the task creation machine learning module 302 may select a particular task template 306 from the one or more task templates 304 based on the characteristics of the project or task identified by the task creation machine learning module 302 from the messages 118, 120 exchanged between the member 110 and the representative 104. For instance, the task creation machine learning module 302, in an embodiment, uses a classification or clustering algorithm to select a particular task template 306 that may be provided to the representative 104 for defining the project or task corresponding to the identified issue that is to be addressed for the benefit of the member 110. The classification or clustering algorithm may generate correlations between different project or task characteristics and corresponding task templates such that, based on the characteristics of a particular project or task identified by the task creation machine learning module 302 from the messages 118, 120 exchanged between the member 110 and the representative 104, the task creation machine learning module 302 may identify an appropriate task template 306 for the identified project or task using the classification or clustering algorithm. As input to this classification or clustering algorithm, the task creation machine learning module 302 may use the corresponding parameters for the new project or task as input to identify, based on output provided by the classification or clustering algorithm, a particular task template 306 that may be used to create the new project or task.

As noted above, the data fields presented in a task template for a project or task can be selected based on a determination generated using a machine learning algorithm or artificial intelligence. The task creation machine learning module 302 may use, as input to the machine learning algorithm or artificial intelligence, a member profile from the user datastore 208 and the task template 306 identified using the classification or clustering algorithm to identify which data fields may be omitted from the task template 306 when presented to the representative 104 for definition of a new task or project. For instance, if the member 110 is known to delegate maintenance tasks to a representative 104 and is indifferent to budget considerations, the task creation machine learning module 302 may present, to the representative 104, a task template 306 for the identified project or task that omits any budget-related data fields and other data fields that may define, with particularity, instructions for completion of the project or task.

In some instances, the task creation machine learning module 302 may allow the representative 104 to add, remove, and/or modify the data fields for the task template 306. For example, if the task creation machine learning module 302 removes a data field corresponding to the budget for a project or task based on an evaluation of the member profile, the representative 104 may request to have the data field added to the task template 306 to allow the representative 104 to define a budget for the project or task based on its knowledge of the member 110. The task creation machine learning module 302, in some instances, may utilize this change to the task template 306 to retrain the machine learning algorithm or artificial intelligence to improve the likelihood of providing task templates 306 to the representative 104 without need for the representative 104 to make any modifications to the task template 306 for defining a new project or task.

In an embodiment, the task creation machine learning module 302 can further obtain feedback with regard to the selection of the task template 306 to retrain the classification or clustering algorithm used to select task templates based on characteristics or parameters associated with particular project/task categories or types. For instance, if a representative 104 indicates that a particular task template 306 provided by the task creation machine learning module 302 is not relevant to the particular issue expressed by the member 110 or otherwise identified based on communications from the member 110, the task creation machine learning module 302 may revise the classification or clustering algorithm to decrease the likelihood of this task template 306 being selected for similar project/task categories or types. Further, if the representative 104 manually selects an alternative task template for the identified issue expressed by the member 110, the task creation machine learning module 302 may use this selection to further revise the classification or clustering algorithm to increase the likelihood of the algorithm selecting this particular task template for similar projects and tasks.

As noted above, the task creation sub-system 202 can automatically populate the data fields presented in a task template 306 based on parameters of the new project or task as identified from messages 118, 120 exchanged over the communications session 116. For instance, the task creation machine learning module 302 may use the parameters for the new project or task gleaned using NLP or other artificial intelligence to automatically populate one or more data fields of the selected task template 306. This may reduce the representative's burden with regard to generating a new project or task using the provided task template 306, as the representative 104 may only need to review the automatically populated information for accuracy.

In addition to selecting a task template 306 for the identified project or task, the task creation machine learning module 302 can further provide, to the representative 104, data corresponding to information that may be required from the member 110 for the identified project or task. For instance, based on the identified information that may be required from the member 110, the task creation machine learning module 302 may automatically generate recommendations for questions that may be presented to the member 110 regarding the project or task based on the member's preferences. In an embodiment, the task creation machine learning module 302 can use a machine learning algorithm or artificial intelligence to determine what questions may be provided to the member 110. For instance, the task creation machine learning module 302 may use the parameters defined for the new project or task, the member's profile from the user datastore 208, and historical data corresponding to projects and/or tasks previously performed for the benefit of the member 110 as input to the machine learning algorithm or artificial intelligence to determine the member's preferences and to identify questions that may be provided to the member 110 based on these preferences to further define the parameters of the new project or task.

As noted above, if the task creation sub-system 202 identifies one or more projects or tasks that may be performed on behalf of the member 110 based on messages exchanged between the member 110 and the representative 104 over the communications session 116, the task creation sub-system 202 may automatically facilitate a communications session 310 that is specific to each identified project or task. This communications session 310 may differ from the original communications session 116 facilitated by the task facilitation service and between the member 110 and the representative 104. This project or task-specific communications session 310 may be presented through an interface that is specific to the identified project or task. For example, as illustrated in FIG. 3, as a result of the task creation sub-system 202 having identified a project corresponding to a request for help in coordinating a move to a new city, the task creation sub-system 202 may automatically generate a new interface corresponding to this identified project or task, through which the task creation sub-system 202 may facilitate a new communications session 310 specific to this project. This new interface may be presented to the member 110 through the application or web portal provided by the task facilitation service.

In response to the data provided by the task creation machine learning module 302, the representative 104, via the communications session 116, may exchange one or more messages 308 with the member 110 over the project-specific communications session 310 to obtain the additional information from the member 110 that may be used to better define the new project or task. For example, as illustrated in FIG. 3, as a result of the task creation machine learning module 302 providing data indicative of the member's propensity to be budget-conscious with regard to projects and tasks performed on its behalf, the representative 104 may ask the member 110 about their budget for moving into a new house. The task creation machine learning module 302 may monitor, in real-time, the communications session 310 specific to the new project and through which the representative 104 submitted their query to the member 110 such that, if the member 110 provides a response to the representative's one or more messages 308, the task creation machine learning module 302 may use the response to automatically populate one or more data fields of the task template 306 provided to the representative 104.

In an embodiment, if the member 110 indicates that the requested information is not necessary (e.g., the member 110 does not care about a budget for the particular project or task, etc.), the task creation machine learning module 302 may transmit a notification to the representative 104 to cease messaging the member 110 with regard to this information. Further, the task creation machine learning module 302 may update the task template 306 to omit any data fields corresponding to the previously requested information, as these may no longer be relevant for the new project or task. In some instances, based on the member's response, the task creation machine learning module 302 may update the machine learning algorithm or artificial intelligence previously used to prompt the representative 104 as to what information may be required from the member 110 to decrease the likelihood of similar prompts being provided to the representative 104 for similar projects or tasks for the member 110 and other similarly-situated members of the task facilitation service. In some instances, the member's response may be used to update the member profile associated with the member 110 and used by the various machine learning algorithms or artificial intelligence maintained by the task creation machine learning module 302 to automatically define new projects and tasks for the member 110. For instance, if the member 110 has indicated that they do not care about budgets for projects or tasks related to vehicle maintenance, the task creation machine learning module 302 may automatically update the member profile associated with the member 110 to indicate that the member 110 is likely not budget conscious for vehicle maintenance projects and tasks. This may reduce the likelihood of the task creation machine learning module 302, through use of its machine learning algorithms or artificial intelligence, prompting the representative 104 to obtain budget information from the member 110 with regard to vehicle maintenance projects and tasks.

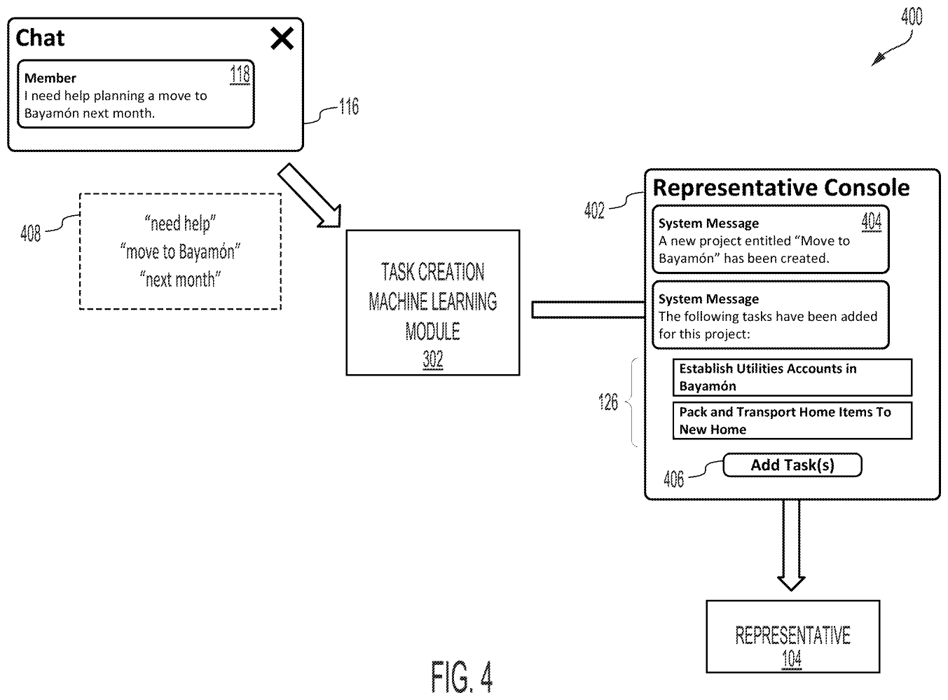

FIG. 4 shows an illustrative example of an environment 400 in which a machine learning algorithm or artificial intelligence is implemented to process messages 118 exchanged between a member and a representative in real-time and as these messages 118 are exchanged to inform a representative 104 of new projects and tasks 126 in accordance with at least one embodiment. As noted above, a member of the task facilitation service and an assigned representative may exchange messages over a communications session 116 to address any issues expressed by the member. For instance, a member may transmit one or more messages 118 over the communications session 116 to express that the member requires assistance from the representative to address a particular issue. As illustrated in FIG. 4, the member has expressed that they require assistance with planning an upcoming move to a new city, which is to take place in the coming month.

In an embodiment, a task creation machine learning module 302 of the task creation sub-system described above in connection with FIGS. 2-3 uses NLP or other artificial intelligence to automatically, and in real-time, process messages exchanged over the communications session 116 as these messages are exchanged to identify one or more projects and/or tasks that may be performed for the benefit of the member. For instance, as illustrated in FIG. 4, the task creation machine learning module 302 may process the message 118 using NLP or other artificial intelligence to identify a set of anchor words or phrases 408 corresponding to a possible project or task that may be created and performed for the benefit of the member. For example, as illustrated in FIG. 4, the task creation machine learning module 302 has identified the anchor phrases 408 “need help” “move to Bayamon” and “next month.” The anchor phrase “need help” may correspond to a request from the member to create a new project or task. The anchor phrase “move to Bayamon” may correspond to the type or category of the new project or task that is to be created (e.g., “move to” may correspond to a moving category of project or task and “Bayamon” may correspond to the location that is to serve as the destination for the move). Additionally, the anchor phrase “next month” may correspond to a temporal limitation for the new project or task, whereby “next month” may denote a deadline for completion of the project or task. Thus, based on the message 118 expressed by the member to request creation of a new project or task, the task creation machine learning module 302 may automatically identify a new project or task, as well as different parameters for the new project or task that may be used to automatically populate a project or task template for the new project or task.

In an embodiment, if the task creation machine learning module 302 identifies a new project or task based on the messages exchanged between the member and the representative 104 over the communications session 116, the task creation machine learning module 302 can select an appropriate project or task template for the identified project or task and begin definition of the new project or task that is to be performed for the benefit of the member. The process for automatically generating the new project or task is described in greater detail in connection with FIG. 3.

In an embodiment, once the task creation machine learning module 302 has defined a new project or task that is to be performed for the benefit of the member, the task creation machine learning module 302 can transmit a notification to the representative 104 to indicate that a new project or task has been created for the member. For instance, as illustrated in FIG. 4, the task creation machine learning module 302 may update a representative console 402 utilized by the representative 104 to provide a new message 404 indicating that a new project or task has been created for the member. The representative console 402 may be implemented as an interface provided by the task facilitation service to representatives associated with the task facilitation service to prompt representatives with regard to available actions or suggestions for managing its relationship with the member. For instance, through the representative console 402, the task facilitation service may provide a representative 104 with information that may assist the representative 104 in communicating with the member in order to assist the member with particular projects and tasks, to ask pertinent questions of the member with regard to performance of projects and tasks, and to indicate when new projects or tasks have been identified and created that are to be performed in order to assist the member with regard to a particular issue expressed by the member. Thus, the representative console 402 may be provided to better guide the representative 104 in assisting the member in order to reduce the member's cognitive load and to better understand the member's needs.

In an embodiment, if the task creation machine learning module 302 has identified a particular project that is to be performed for the benefit of the member, the task creation machine learning module 302 can automatically create one or more tasks 126 that may be performed in order to complete the new project. For instance, the task creation machine learning module 302 may access a resource library maintained by a task coordination system of the task facilitation service to identify one or more tasks that may be associated with the particular project category or type of the new project identified based on the member's message 118. As noted above, the resource library may include detailed information related to different resources available for performance of a project or task. Further, the resource library may specify common tasks that are typically performed in order to complete different projects. These common tasks may be categorized according to the corresponding project category or type. Thus, based on the category or type of the new project, the task creation machine learning module 302 may query the resource library to identify one or more tasks 126 that may be performed for the benefit of the member in order to complete the new project.

In some instances, the task creation machine learning module 302 may use a machine learning algorithm or artificial intelligence to identify and create tasks that may be performed for completion of the identified project. For example, the task creation machine learning module 302 may utilize historical data corresponding to previously identified projects and tasks for similarly situated members, as well as the characteristics or parameters associated with the new project, as input to a machine learning algorithm or artificial intelligence to identify a set of possible tasks that may be performed in order to complete the new project. As an illustrative example, if the new project corresponds to a move to a new city, the task creation machine learning module 302, based on historical data corresponding to previous projects completed for similarly situated members and associated with moves to new cities, may identify one or more tasks previously performed for these similarly situated members in order to complete their moves to new cities. Accordingly, based on the identified one or more tasks, the task creation machine learning module 302 may automatically generate one or more tasks for the new project that are specific to the member's needs and in accordance with the member's preferences. In some instances, based on the identified one or more tasks, the task creation machine learning module 302 may retrieve task templates corresponding to these identified one or more tasks and generate new tasks using these task templates. The task creation machine learning module 302 may populate these task templates using the information garnered from the member's one or more messages 118 exchanged over the communications session 116.

In an embodiment, if the task creation machine learning module 302 automatically generates one or more tasks 126 for the newly identified project, the task creation machine learning module 302 can update the representative console 402 to present these tasks 126 to the representative 104. Through the representative console 402, the representative 104 may review the new tasks 126 generated for the project. For instance, the representative 104, through the representative console 402, may select a particular task 126 in order to review the parameters associated with the task 126 (e.g., timeframe for completion of the task 126, any third-party services to be engaged for completion of the task 126, any budget requirements, actions to be performed for the task, etc.). Further, the representative 104 may access the task template for the particular task 126 to provide any additional information that may be required for the task 126. For instance, if the task 126 does not indicate a budget for performance of the task 126, but the representative 104 is privy to the budget set forth by the member for completion of the task 126, the representative 104 may update the task template for the task 126 to indicate the member's budget for completion of the task 126.

As noted above, the task creation machine learning module 302 may automatically generate recommendations for questions that may be presented to the member regarding the presented tasks 126 based on the member's preferences. These recommendations may be provided to the representative 104 via the representative console 402. For instance, when a representative 104 interacts with a particular task 126, the task creation machine learning module 302, via the representative console 402, may provide these recommendations to the representative 104. This may allow the representative 104 to readily determine what additional information may be required from the member in order to complete definition of the project and corresponding tasks 126.

Through the representative console 402, the task creation machine learning module 302 may provide the representative 104 with an option 406 to define additional and/or alternative tasks for the new project. For instance, if the representative 104 identifies additional tasks that the member would like additional assistance with for the project, the representative 104 may select the option 406 to access task templates for these additional tasks in order to define these additional tasks. If the representative 104 defines a new task for the project, the new task may be added to the tasks 126 presented via the representative console 402 for the new project. In some instances, if the representative 104 creates a new task for the project, the task creation machine learning module 302 can add this new task to the historical data that may be used by the task creation machine learning module 302 to identify tasks for similar projects and for similarly situated members. Thus, if the representative 104 adds, removes, or modifies tasks for a particular project, the task creation machine learning module 302 may automatically use this data to further train the machine learning algorithm or artificial intelligence used to automatically generate tasks for projects that are to be performed for the benefit of similarly situated members.

In an embodiment, in addition to updating a representative console 402 utilized by the representative 104 to provide a new message 404 indicating that a new project or task has been created for the member, the task creation machine learning module 302 can automatically facilitate a new communications session between the member and the representative 104 that is specific to the new project or task created for the member. For example, through the application or web portal provided by the task facilitation service to a member of the task facilitation service, the task creation machine learning module 302 may generate a new project- or task-specific interface corresponding to the newly created project or task. Through this new interface, the task creation machine learning module 302 may facilitate a new communications session between the member and the representative 104, through which the representative 104 may present the member with any questions recommended by the task creation machine learning module 302 for the associated project or task.

In some instances, if the task creation machine learning module 302 generates one or more new tasks 126 for the newly identified project, the task creation machine learning module 302 may update the project-specific interface generated for the newly identified project to present these one or more new tasks 126. If the member selects any of the one or more new tasks 126, the task facilitation service may update the project-specific interface to provide a task-specific interface corresponding to the selected new task. Through this task-specific interface, the member may communicate with the representative 104 through a task-specific communications session facilitated between the member and the representative 104 and through which the member and the representative 104 may communicate with one another concerning the selected new task. Further, through this task-specific interface, the member may provide any additional information that may be used by the representative 104 and/or any third-party service or other entity assigned to the new task in completing the task on behalf of the member.

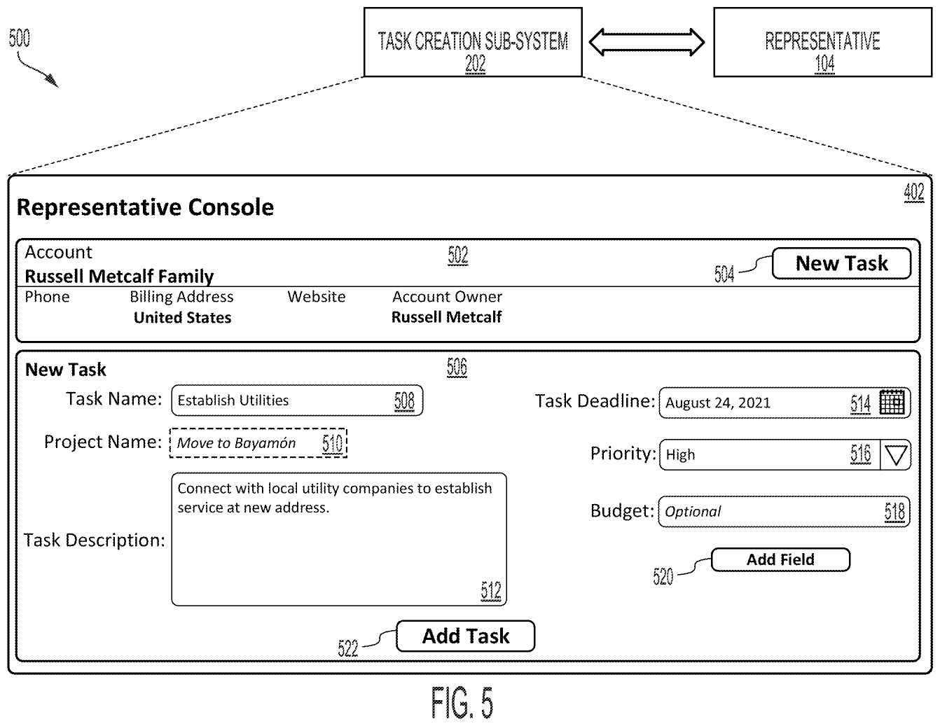

FIG. 5 shows an illustrative example of an environment 500 in which a task creation sub-system 202 provides, via a representative console 402, a task template for the creation of a new task to be performed for the benefit of a member in accordance with at least one embodiment. As noted above, the task creation sub-system 202 may maintain, in a task datastore, project and task templates for different project/task types or categories. Each project or task template may include different data fields for defining the project or task, whereby the different project or task fields may correspond to the project/task type or category for the project or task being defined. The representative 104 and/or the member may provide information related to the issue that is to be addressed via these different fields to define the project or task that may be submitted to the task creation sub-system 202 for processing.

As illustrated in FIG. 5, the task creation sub-system 202, via the representative console 402, may provide an account window 502, through which the representative 104 may review account information associated with the member and submit a request to create a new task or project for the member. For instance, the account window 502 may include an account name (e.g., unique label associated with the account as defined by the member, the representative 104, or by the task facilitation service based on characteristics of the account, etc.), a phone number associated with the account, a billing address or other address associated with the account, a website associated with the account, an account holder's name (e.g., the member or other entity that serves as the owner of the account), and the like. This information may be used to uniquely identify the account associated with the member for the benefit of the representative 104.

In an embodiment, the account window 502 can include a new task button 504, through which the representative 104 can submit a request to the task creation sub-system 202 to generate a new task or project for the member represented in the account window 502. If the representative 104 selects the new task button 504, the task creation sub-system 202 may present a task template via a task creation window 506. The initial task template provided via the task creation window 506 may be a generic or universal task template that may be used to define any number of different task or project parameters for a new task or project, respectively. For instance, as illustrated in FIG. 5, the task creation sub-system 202 may present a task name field 508, through which the representative 104 may enter or define a name for the new task. Additionally, the task creation sub-system 202 may provide a project name field 510, which may specify the name of the project for which the task is being generated (if a task rather than a project is being defined). If a project is being defined via the representative console 402, the project name field 510 may be omitted.

The task creation sub-system 202 may further provide, via the task creation window 506, a task description field 512, through which the representative 104 may provide a short description of the new task or project being generated for the member. In an embodiment, once the representative 104 has provided a name and short description for the project or task, the task creation sub-system 202, using a machine learning algorithm or artificial intelligence, may use the provided name and short description, as well as historical data corresponding to the member and similarly situated members (e.g., previous projects and/or tasks created for the member and similarly situated members, etc.), as input to select a particular task template that may be presented to the representative 104 via the task creation window 506. For example, if the representative 104 provides a task name corresponding to a task for establishing utilities in a new town and provides as a short description that the task is for connecting with local utility companies to establish service at a new address, the task creation sub-system 202, using the machine learning algorithm or artificial intelligence, may identify a task template corresponding to moving or utility tasks. Accordingly, the task creation sub-system 202 may update the task creation window 506 automatically to present data fields corresponding to the identified task template and import the previously provided information into any applicable data fields of the identified template. Thus, based on the identified task category or type, the representative 104 may be presented with relevant data fields for defining the task.

In an embodiment, the task creation sub-system 202 can automatically provide a task template via the task creation window 506 for a task or project automatically identified from the messages exchanged between the member and the representative 104 over the communications session between the member and the representative. For instance, if the task creation sub-system 202 identifies a new task or project based on the messages exchanged between the member and the representative 104, the task creation sub-system 202 may automatically identify a corresponding template for the new task or project and populate any applicable data fields associated with the template for the new task or project based on information gleaned from these messages. As noted above, if the task creation sub-system 202 identifies a new project or task based on the messages exchanged between the member and the representative 104, the task creation sub-system 202 may automatically notify the representative 104 of this new task or project. This notification may be provided through the representative console 402, through which the representative 104 may review the new project or task via the task creation window 506. Further, through the task creation window 506, the representative 104 may make any changes to the newly identified task or project based on its knowledge of the member and/or of the project or task that the member wishes to have performed on their behalf.

Returning to the creation of a new task or project via the task creation window 506, the task creation sub-system 202 may further provide a task deadline field 514, through which the representative 104 may define a deadline for completion of the task or project. In some instances, this task deadline field 514 may be automatically updated by the task creation sub-system 202 based on the messages exchanged between the member and the representative 104. Using the illustrative example described above in connection with FIGS. 1, 3, and 4 related to an upcoming move to Bayamon, the task creation sub-system 202 may use NLP or other artificial intelligence to process the messages exchanged between the member and the representative 104 to determine that the deadline for the upcoming move is in the next month. Accordingly, the task creation sub-system 202 may automatically calculate, based on this identified statement from the member, a corresponding deadline for the project. Accordingly, the task creation sub-system 202 may automatically update the task deadline field 514 to indicate this calculated deadline. The representative 104, based on their own knowledge of the member and of the project or task specified by the member, may modify this original deadline through the task deadline field 514 if necessary.

The task creation sub-system 202 may further provide, via the task creation window 506, a priority field 516, through which a priority may be assigned for the particular task or project. For instance, if the representative 104 determines, based on their knowledge of the member and of the task or project, that the member considers the particular project or task to be of utmost importance, the representative 104 may assign a high priority to the project or task via the priority field 516. Conversely, if the representative 104 determines that the project or task is not an urgent one and is one that can be performed at any time without any negative impact to the member, the representative 104 may assign a lower priority to the project or task via the priority field 516. This assignment of a priority may be used by the task recommendation system as a factor in ranking the various tasks and projects identified by the representative 104 and/or task recommendation system for the member.

In an embodiment, the task creation sub-system 202 can automatically assign a priority to the task or project via the priority field 516 based on the messages corresponding to the project or task exchanged between the member and the representative. For instance, using NLP or other artificial intelligence, if the task creation sub-system 202 identifies a level of urgency on the part of the member for addressing a particular issue, the task creation sub-system 202 may ascribe a high level of urgency and, thus, a high priority for the project or task. Indicators of urgency may include semantic and non-semantic characteristics of the messages exchanged between the member and the representative 104. For instance, if the member uses anchor terms indicative of an urgent need for completion of a task or project (e.g., “now,” “immediately,” “as soon as possible,” “ASAP,” etc.), the task creation sub-system 202 may determine that there is a high level or urgency in having the task or project completed quickly. Additionally, if the member's typing frequency is elevated, the member is making more frequent typographical errors, the member is using exclamatory symbols, etc., the task creation sub-system 202 may use these as indicators of a high level of urgency for completion of the task or project. Accordingly, the task creation sub-system 202 may update the priority field 516 to indicate a high priority for completion of the identified task or project.

The task creation sub-system 202, via the task creation window 506, may further provide a budget field 518, through which a budget for completion of the task or project may be defined. For instance, the representative 104, based on its knowledge of the member and of the particular task or project being created, may define a budget for completion of the task or project via the budget field 518. In some instances, if the representative 104 knows that the member is not budget conscious with regard to performance of projects and tasks, the representative 104 may omit providing a budget via the budget field 518. Thus, the definition of a budget via the budget field 518 may be optional, as illustrated in FIG. 5. In an embodiment, the task creation sub-system 202 can automatically define a budget for the task or project based on an evaluation of the member's profile and of similar tasks or projects previously performed for similarly situated members of the task facilitation service. For instance, if the member is not budget conscious but, based on similar tasks or projects previously performed for similarly situated members, the task creation sub-system 202 determines an average estimated cost for completion of the project or task, the task creation sub-system 202 may define a budget via the budget field 518 that corresponds to this average estimated cost. In some instances, if the task creation sub-system 202 determines, based on an evaluation of the member's profile, that the member is not budget conscious, the task creation sub-system 202 may omit the budget field 518 entirely from the task creation window 506.

The task creation window 506 may further include an add field button 520, which the representative 104 may utilize to add one or more data fields for the task or project to further define additional parameters for the new task or project. As an illustrative example, if the representative 104 determines that the member is concerned with regard to what brands or services are used for performance of their tasks, the representative 104 may add one or more data fields corresponding to selection or identification of brands or services for performance of the task or project. As another illustrative example, if the representative 104 knows that the member is interested in ratings related to brands or services used for the performance of the task or project, the representative 104 may add a data field for the task or project corresponding to brand or service ratings that may be presented to the member.

As noted above, the data fields presented in a template for a project or task can be selected based on a determination generated using a machine learning algorithm or artificial intelligence. The task creation sub-system 202 can use, as input to the machine learning algorithm or artificial intelligence, a member profile from the user datastore and the selected template from the task datastore to identify which data fields may be omitted from the template when presented to the representative 104 via the task creation window 506 for definition of a new task or project. For instance, if the member is known to delegate maintenance tasks to a representative 104 and is indifferent to budget considerations, the task creation sub-system 202 may present, to the representative 104, a task template that omits any budget-related data fields and other data fields that may define, with particularity, instructions for completion of the task.

Through use of the add field button 520 and through other interface elements associated with optional fields presented via the task creation window 506, the task creation sub-system 202 may allow the representative 104 to add, remove, and/or modify the data fields for the template. For example, if the task creation sub-system 202 removes a data field corresponding to the budget for the task based on an evaluation of the member profile, the representative 104 may use the add field button 520 to request that the data field be added to the template to allow the representative 104 to define a budget for the task based on its knowledge of the member. The task creation sub-system 202, in some instances, may utilize this change to the template to retrain the machine learning algorithm or artificial intelligence to improve the likelihood of providing templates to the representative 104 via the task creation window 506 without need for the representative 104 to make any modifications to the template for defining a new project or task.

Once the new project or task has been defined via the task creation window 506, the representative 104 may select an add task button 522 provided via the task creation window 506 to submit the newly created task or project. The task creation sub-system 202 may add the new project or task to the listing of tasks or projects that are to be performed for the benefit of the member. Further, the newly created task or project may be ranked according to a likelihood of the member selecting the task or project for delegation to the representative 104 for performance and coordination with third-party services. Alternatively, the new task or project may be ranked based on the level of urgency for completion of each project or task. The level of urgency may be determined based on member characteristics from the user datastore (e.g., data corresponding to a member's own prioritization of certain tasks or categories of tasks) and/or potential risks to the member if the task or project is not performed.

In an embodiment, selection of the add task button 522 causes the task creation sub-system 202 to update the interface generated for the corresponding project or task to include the information defined by the representative 104 and/or by the task creation sub-system 202 through the task creation window 506. As noted above, if the task creation sub-system 202 identifies a project or task that may be performed in order to address an issue expressed by the member over the original communications session facilitated between the member and the representative 104, the task creation sub-system 202 may automatically generate a new interface for the newly identified project or task. Through this new interface, the task creation sub-system 202 may facilitate a communications session that is specific to the identified project or task. Further, in response to selection of the add task button 522, the task creation sub-system 202 may automatically update this interface to provide any updated information related to the identified project or task and provided by the representative 104 or otherwise identified by the task creation sub-system 202 and defined through the task creation window 506.

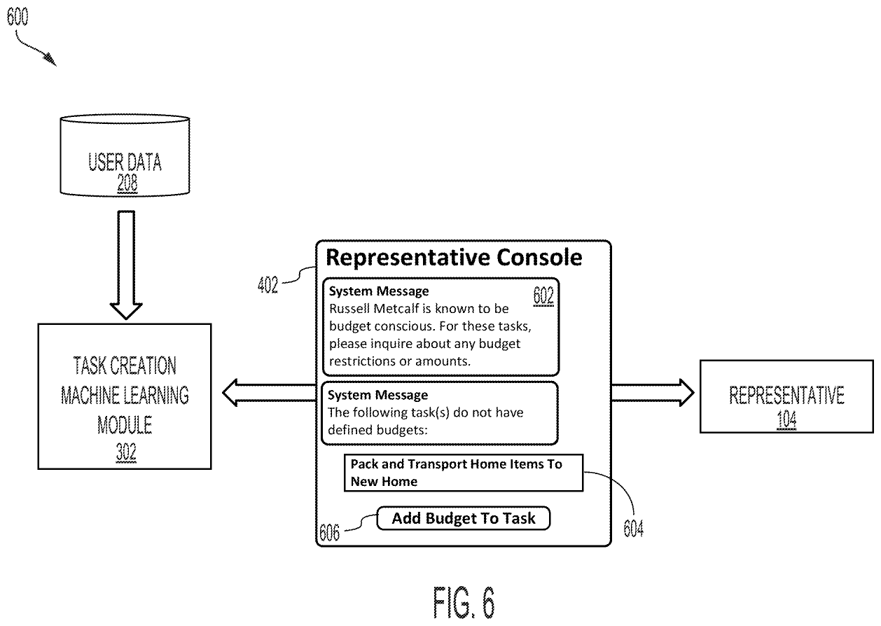

FIG. 6 shows an illustrative example of an environment 600 in which a machine learning algorithm or artificial intelligence automatically identifies additional information that is required from a member for defining new projects and tasks in accordance with at least one embodiment. In the environment 600, the task creation machine learning module 302 may automatically, and in real-time, identify any additional information that may be required from a member for a particular project or task. As noted above, the task creation machine learning module 302 may process a newly generated project and/or task and information corresponding to the member using a machine learning algorithm or artificial intelligence to automatically identify additional parameters for the project or task, as well as any additional information that may be required from the member for the generation of proposals associated with the project or task. For instance, the task creation machine learning module 302 may use the generated project or task, information corresponding to the member, and historical data corresponding to projects and/or tasks performed for other similarly-situated members as input to the machine learning algorithm or artificial intelligence to identify any additional information that may be required of the member for defining the project and/or task. The task creation machine learning module 302 may obtain the historical data corresponding to the projects and/or tasks performed for other similarly-situated members and information corresponding to the member from a user datastore 208. In some instances, the task creation machine learning module 302 may use information from the user datastore 208 to identify the projects and/or tasks previously performed for other similarly-situated members and for the member itself. Once the task creation machine learning module 302 has identified these projects and/or tasks, the task creation machine learning module 302 may access a task datastore, such as task datastore 210 described above, to obtain these projects and/or tasks for use as input in the machine learning algorithm or artificial intelligence.

If the task creation machine learning module 302 determines that additional member input is required for the newly generated project or task, the task creation machine learning module 302 may provide the representative 104 with recommendations for questions that may be presented to the member regarding the project or task. For example, via a representative console 402 provided to the representative 104 by the task facilitation service, the task creation machine learning module 302 may transmit one or more messages to the representative 104 indicating what additional information may be required from the member for the newly generated project or task. Returning to the “Move to Bayamon” project example illustrated in FIG. 1, if the task creation machine learning module 302 determines that it is important to understand one or more parameters of the member's home (e.g., square footage, number of rooms, etc.) for the project, the task creation machine learning module 302 may transmit a message to the representative 104 via the representative console 402 to provide a recommendation to the representative 104 to prompt the member to provide these one or more parameters. The representative 104 may review the recommendations provided by the task creation machine learning module 302 and, via the communications session established between the member and the representative 104 for the particular project, prompt the member to provide the additional project parameters.

In an embodiment, the task creation machine learning module 302 can further provide the representative 104, via the representative console 402, with recommendations for questions that may be presented to the member regarding the project or task based on the member's preferences. For example, if the member is known to be budget conscious, and the representative 104 and/or the task creation machine learning module 302 has not defined any budgets or budget restrictions for the task or project, the task creation machine learning module 302 may prompt the representative 104, via the representative console 402, to communicate with the member via the communications session established between the member and the representative 104 for the particular task or project to inquire about the member's budget for completion of the project or task. For example, as illustrated in FIG. 6, the task creation machine learning module 302 may transmit a message 602 to the representative 104 indicating that the member is known to be budget conscious and, as such, the representative 104 should inquire about any budget restrictions or amounts for the newly generated project or task. Further, through the representative console 402, the task creation machine learning module 302 may specify which tasks 604 have been newly generated but are missing the additional information identified by the task creation machine learning module 302 as being important for these tasks 604 based on the member's preferences (as defined and identified via the member's profile and/or through evaluation of preferences for similarly-situated members).

As noted above, the task creation machine learning module 302 can use a machine learning algorithm or artificial intelligence to determine what questions may be provided to the member. For instance, the task creation machine learning module 302 may use the parameters defined for the new project or task, the member's profile, and historical data corresponding to projects and/or tasks previously performed for the benefit of the member as input to the machine learning algorithm or artificial intelligence to determine the member's preferences and to identify questions that may be provided to the member based on these preferences to further define the parameters of the new project or task. Based on the output of this machine learning algorithm or artificial intelligence, the task creation machine learning module 302 may transmit one or more messages 602 to the representative 104 providing recommendations with regard to questions that may be provided to the member to further define the newly generated projects and/or tasks.

In an embodiment, through the representative console 402, the task creation machine learning module 302 can provide an add information button 606 that may be selected to access the template corresponding to the identified tasks and/or projects for which additional information may be required. The add information button 606 may be specific to the particular information that needs to be added for the identified tasks and/or projects. For example, as illustrated in FIG. 6, the task creation machine learning module 302 has provided an add information button 606 that is specific to defining a budget for the identified task 604 presented in the representative console 402. If the representative 104 selects the add information button 606, the task creation machine learning module 302 may present, via the representative console 402, the template corresponding to the task 604 specified in the representative console 402. If multiple tasks or projects are presented via the representative console 402, selection of the add information button 606 may cause the task creation machine learning module 302 to present the representative 104 with an option to select which task or project the representative 104 would like to amend to provide the additional information. In some instances, instead of presenting the template for a corresponding task or project via the representative console 402 in response to selection of the add information button 606, the task creation machine learning module 302 may prompt the representative 104 to provide the additional information via the representative console 402. If the representative 104 provides this information to the task creation machine learning module 302, the task creation machine learning module 302 may automatically update the template corresponding to the task or project to input this additional information for the task or project.

It should be noted that in some instances, rather than prompting the representative 104 to obtain additional information that may be pertinent to the member for the newly generated tasks and/or projects, the task creation machine learning module 302 may automatically communicate directly with the member via the communications session previously established between the member and the representative 104 for the particular project or task. For instance, the task creation machine learning module 302 may automatically communicate with the member to obtain any additional information required for new projects and tasks and automatically generate proposals that may be presented to the member for performance of these projects and tasks. The representative 104 may monitor communications between the task creation machine learning module 302 and the member to ensure that the conversation maintains a positive polarity (e.g., the member is satisfied with its interaction with the task creation machine learning module 302 or other bot, etc.). If the representative 104 determines that the conversation has a negative polarity (e.g., the member is expressing frustration, the task creation machine learning module 302 or bot is unable to process the member's responses or asks, etc.), the representative 104 may intervene in the conversation.

In an embodiment, the representative 104 or member can indicate that the additional information identified by the task creation machine learning module 302 is not required for one or more newly generated projects and/or tasks. For instance, via the representative console 402, the representative 104 may indicate that, based on their knowledge of the member and/or in response to the member indicating that the additional information is not required, the additional information identified by the task creation machine learning module 302 is not required for one or more newly generated projects and/or tasks. Accordingly, the task creation machine learning module 302 may update the template for each project and/or task to omit this additional information and finalize creation of the new projects and/or tasks. Further, based on this feedback from the representative 104 or member, the task creation machine learning module 302 may update the machine learning algorithm or artificial intelligence used to identify what additional information may be required for new projects and tasks to decrease the likelihood of similar prompts for additional information being presented to the representative 104 or member by the task creation machine learning module 302 for similar projects and/or tasks and for similarly-situated members. For example, if a member indicates that they are not concerned with budgets for tasks and projects related to vehicle maintenance, and the task creation machine learning module 302 previously determined that the member should be prompted with regard to budgets for tasks and projects related to vehicle maintenance, the task creation machine learning module 302 may automatically update the machine learning algorithm or artificial intelligence used to determine what additional information may be required for these projects and tasks to reduce the likelihood of the task creation machine learning module 302 prompting the representative 104 or member for additional information related to budgets for similar projects or tasks related to vehicle maintenance.

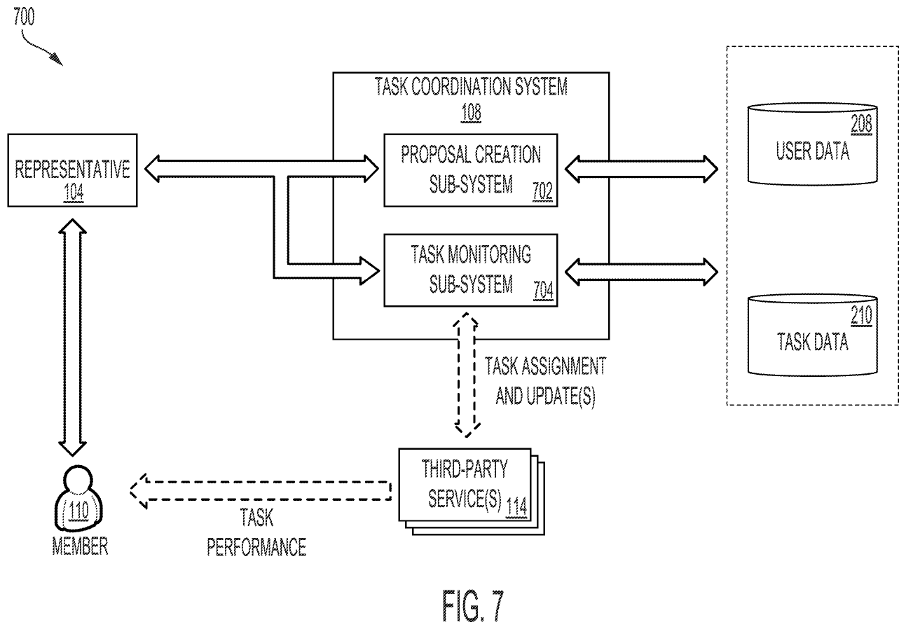

FIG. 7 shows an illustrative example of an environment 700 in which a task coordination system 108 assigns and monitors performance of a task for the benefit of a member 110 by a representative 104 and/or one or more third-party services 114 in accordance with at least one embodiment. In the environment 700, a representative 104 may access a proposal creation sub-system 702 of the task coordination system 108 to generate a proposal for completion of a project or task for the benefit of the member 110. The proposal creation sub-system 702 may be implemented using a computer system or as an application or other executable code implemented on a computer system of the task coordination system 108. Once the representative 104 has obtained the necessary project or task-related information from the member 110 and/or through the task recommendation system (e.g., task parameters garnered via evaluation of tasks performed for similarly situated members, etc.), the representative 104 can utilize the proposal creation sub-system 702 to generate one or more proposals for resolution of the project or task.

A proposal may include one or more options presented to a member 110 that may be created and/or collected by a representative 104 while researching a given project or task. In some instances, a representative 104 may access, via the proposal creation sub-system 702, one or more templates that may be used to generate these one or more proposals. For example, the proposal creation sub-system 702 may maintain, within the task datastore 210 or internally, proposal templates for different project and task types, whereby a proposal template for a particular project or task type may include various data fields associated with the project or task type. The task datastore 210 may be associated with a resource library that maintains the various proposal templates for the creation of new proposals for completion of different projects and tasks.

In an embodiment, the data fields within a proposal template can be toggled on or off to provide a representative 104 with the ability to determine what information is presented to the member 110 in a proposal. The representative 104, based on their knowledge of the member's preferences, may toggle on or off any of these data fields within the template. For example, if the representative 104 has established a relationship with the member 110 whereby the representative 104, with high confidence, knows that the member trusts the representative 104 in selecting reputable businesses for its projects and tasks, the representative 104 may toggle off a data field corresponding to the ratings/reviews for corresponding businesses from the proposal template. Similarly, if the representative 104 knows that the member 110 is not interested in the location/address of a business for the purpose of the proposal, the representative 104 may toggle off the data field corresponding to the location/address for corresponding businesses from the proposal template. While certain data fields may be toggled off within the proposal template, the representative 104 may complete these data fields to provide additional information that may be used by the proposal creation sub-system 702 to supplement proposals maintained by the task coordination system 108 within the resource library.

In an embodiment, the proposal creation sub-system 702 utilizes a machine learning algorithm or artificial intelligence to generate recommendations for the representative 104 regarding data fields that may be presented to the member 110 in a proposal. The proposal creation sub-system 702 may use, as input to the machine learning algorithm or artificial intelligence, a member profile associated with the member 110 from the user datastore 208, historical task and project data for the member 110 from the task datastore 210, and information corresponding to the project or task for which a proposal is being generated (e.g., a project/task type or category, etc.). The output of the machine learning algorithm or artificial intelligence may specify which data fields of a proposal template should be toggled on or off. The proposal creation sub-system 702, in some instances, may preserve, for the representative 104, the option to toggle on these data fields in order to provide the representative 104 with the ability to present these data fields to the member 110 in a proposal. For example, if the proposal creation sub-system 702 has automatically toggled off a data field corresponding to the estimated cost for completion of a project or task, but the member 110 has expressed an interest in the possible cost involved, the representative 104 may toggle on the data field corresponding to the estimated cost.

Once the representative 104 has generated a new proposal for the member 110, the representative 104 may present the proposal and any corresponding proposal options to the member 110. Further, the proposal creation sub-system 702 may store the new proposal in the user datastore 208 in association with a member profile. In some instances, when a proposal is presented to a member 110, the proposal creation sub-system 702 may automatically, and in real-time, monitor member interaction with the representative 104 and with the proposal to obtain data that may be used to further train the machine learning algorithm or artificial intelligence. For example, if a representative 104 presents a proposal without any ratings/reviews for a particular business based on the recommendation generated by the proposal creation sub-system 702, and the member 110 indicates (e.g., through messages to the representative 104, through selection of an option in the proposal to view ratings/reviews for the particular business, etc.) that they are interested in ratings/reviews for the particular business, the proposal creation sub-system 702 may utilize this feedback to further train the machine learning algorithm or artificial intelligence to increase the likelihood of recommending presentation of ratings/reviews for businesses selected for similar projects/tasks or project/task types.

As noted above, task coordination system 108 may maintain a resource library that may be used to automatically populate one or more data fields of a particular proposal template. The resource library may include entries corresponding to businesses and/or products previously used by representatives for proposals related to particular projects/tasks or project/task types or that are otherwise associated with particular projects/tasks or project/task types. For instance, when a representative 104 generates a proposal for a task related to repairing a roof near Lynnwood, Wash., the proposal creation sub-system 702 may obtain information associated with the roofer selected by the representative 104 for the task. The proposal creation sub-system 702 may generate an entry corresponding to the roofer in the resource library and associate this entry with “roof repair” and “Lynnwood, Wash.” Thus, if another representative receives a task corresponding to repairing a roof for a member located near Lynnwood, Wash., the other representative may query the resource library for roofers near Lynnwood, Wash. The resource library may return, in response to the query, an entry corresponding to the roofer previously selected by the representative 104. If the other representative selects this roofer, the proposal creation sub-system 702 may automatically populate the data fields of the proposal template with the information available for the roofer from the resource library.

The representative 104 can query the resource library to identify one or more third-party services and other services/entities affiliated with the task facilitation service from which to solicit quotes for completion of the project or task. For instance, for a newly created project or task, the representative 104 may transmit a job offer to these one or more third-party services 114 and other services/entities. Through an application or web portal provided by the task facilitation service, a third-party service or other service/entity may review the job offer and determine whether to submit a quote for completion of the project or task or to decline the job offer. If a third-party service or other service/entity opts to reject the job offer, the representative 104 may receive a notification indicating that the third-party service or other service/entity has declined the job offer. Alternatively, if a third-party service or other service/entity opts to bid to perform the project or task, the third-party service or other service/entity may submit a quote for completion of the project or task. The representative 104 may use any provided quotes from the third-party services 114 and/or other services/entities to generate different proposal options for completion of the project or task. These different proposal options may be presented as a proposal to the member 110 through the project- or task-specific interface corresponding to the particular project or task that is to be completed. If the member 110 selects a particular proposal option from the set of proposal options presented through the project- or task-specific interface, the representative 104 may transmit a notification to the third-party service or other service/entity that submitted the quote associated with the selected proposal option to indicate that it has been selected for completion of the project or task.

As noted above, the representative 104, via a proposal template, may generate additional proposal options for businesses and/or products that may be used for completion of a project or task. For instance, for a particular proposal, the representative 104 may generate a recommended option, which may correspond to the business or product that the representative 104 is recommending for completion of a task. Additionally, in order to provide the member 110 with additional options or choices, the representative 104 can generate additional options corresponding to other businesses or products that may complete the project or task. In some instances, if the representative 104 knows that the member 110 has delegated the decision-making with regard to completion of a project or task to the representative 104, the representative 104 may forego generation of additional proposal options outside of the recommended option. However, the representative 104 may still present, to the member 110, the selected proposal option for completion of the project or task in order to keep the member 110 informed about the status of the project or task.

Once the representative 104 has completed defining a proposal via use of a proposal template, the representative 104 may present the proposal to the member 110 through the communications session established between the member 110 and the representative 104 and/or through an application or web portal provided by the task facilitation service. In some instances, the representative 104 may transmit a notification to the member 110 to indicate that a proposal has been prepared for a particular project or task and that the proposal is ready for review via the application or web portal provided by the task facilitation service. The proposal presented to the member 110 may indicate the project or task for which the proposal was prepared, as well as an indication of the one or more options that are being provided to the member 110. For instance, the proposal may include links to the recommended proposal option and to the other options (if any) prepared by the representative 104 for the particular project or task. These links may allow the member 110 to navigate amongst the one or more options prepared by the representative 104 via the application or web portal. In some instances, the representative 104 may transmit the proposal to the member 110 via other communication channels, such as via e-mail, text message, and the like.

For each proposal option, the member 110 may be presented with information corresponding to the business or product selected by the representative 104 and corresponding to the data fields selected for presentation by the representative 104 via the proposal creation sub-system 702. In some instances, the member 110 may select what details or data fields associated with a particular proposal are presented via the application or web portal. For example, if the member 110 is presented with the estimated total for each proposal option and the member 110 is not interested in reviewing the estimated total for each proposal option, the member 110 may toggle off this particular data field from the proposal via the application or web portal. Alternatively, if the member 110 is interested in reviewing additional detail with regard to each proposal option (e.g., additional reviews, additional business or product information, etc.), the member 110 may request this additional detail to be presented via the proposal.

As noted above, based on member interaction with a provided proposal, the proposal creation sub-system 702 may further train a machine learning algorithm or artificial intelligence used to determine or recommend what information should be presented to the member 110 and to similarly-situated members for similar projects/tasks or project/task types. The proposal creation sub-system 702 may automatically, and in real-time, monitor or track member interaction with the proposal to determine the member's preferences regarding the information presented in the proposal for the particular project or task. Further, the proposal creation sub-system 702 may automatically, and in real-time, monitor or track any messages exchanged between the member 110 and the representative 104 related to the proposal to further identify the member's preferences. In some instances, the proposal creation sub-system 702 may solicit feedback from the member 110 with regard to proposals provided by the representative 104 to identify the member's preferences. This feedback and information garnered through member interaction with the representative 104 regarding the proposal and with the proposal itself may be used to retrain the machine learning algorithm or artificial intelligence to provide more accurate or improved recommendations for information that should be presented to the member 110 and to similarly situated members in proposals for similar projects/tasks or project/task types. The proposal creation sub-system 702 may further use the feedback and information garnered through member interaction with the representative 104 to update a member profile or model within the user datastore 208 for use in determining recommendations for information that should be presented to the member 110 in a proposal.

In some instances, each proposal presented to the member 110 may specify any costs associated with each proposal option. These costs may be presented in different formats based on the requirements of the associated task or project. For instance, if the proposal corresponds to performance of the task by a third-party service or other service/entity associated with the task facilitation service, the proposal may include a quote submitted by the third-party service or other service/entity in response to the job offer from the representative 104. The quote may indicate any costs associated with different aspects of the project or task, as well as any additional fees that may be required for performance of the project or task (e.g., taxes, material costs, etc.). If a member 110 accepts a particular proposal option for a task or project, the representative 104 may communicate with the member 110 to ensure that the member is consenting to payment of the presented costs and any associated taxes and fees for the particular proposal option. In some instances, if a proposal option is selected with a static payment amount, the member 110 may be notified by the representative 104 if the actual payment amount required for fulfillment of the proposal option exceeds a threshold percentage or amount over the originally presented static payment amount.

In an embodiment, if a member 110 accepts a proposal option from the presented proposal, the task coordination system 108 moves the project or task associated with the presented proposal to an executing state and the representative 104 can proceed to execute on the proposal according to the selected proposal option. For instance, the representative 104 may contact one or more third-party services 114 to coordinate performance of the project or task according to the parameters defined in the proposal accepted by the member 110. Alternatively, if the representative 104 is to perform the project or task for the benefit of the member 110, the representative 104 may begin performance of the project or task according to the parameters defined in the proposal accepted by the member 110.

In an embodiment, the representative 104 utilizes a task monitoring sub-system 704 of the task coordination system 108 to assist in the coordination of performance of the project or task according to the parameters defined in the proposal accepted by the member 110. The task monitoring sub-system 704 may be implemented using a computer system or as an application or other executable code implemented on a computer system of the task coordination system 108. If the coordination with a third-party service 114 may be performed automatically (e.g., third-party service 114 provides automated system for ordering, scheduling, payments, etc.), the task monitoring sub-system 704 may interact directly with the third-party service 114 to coordinate performance of the project or task according to the selected proposal option. The task monitoring sub-system 704 may provide any information from a third-party service 114 to the representative 104. The representative 104, in turn, may provide this information to the member 110 via the communications session between the member 110 and the representative 104 and/or through the application or web portal utilized by the member 110 to access the task facilitation service. Alternatively, the representative 104 may transmit the information to the member 110 via other communication methods (e.g., e-mail message, text message, etc.) to indicate that the third-party service 114 has initiated performance of the project or task according to the selected proposal option. If the project or task is to be performed by the representative 104 for the benefit of the member 110, the task monitoring sub-system 704 may monitor and interact with the representative 104 to coordinate performance of the project or task according to the parameters defined in the proposal option accepted by the member 110. For instance, the task monitoring sub-system 704 may provide the representative 104 with any resources (e.g., payment information, task information, preferred sources for purchases, etc.) that may be required for performance of the project or task.

In an embodiment, the task monitoring sub-system 704 can monitor performance of projects and tasks by the representative 104 and/or third-party services 114 for the benefit of the member 110. For instance, the task monitoring sub-system 704 may record any information provided by the third-party services 114 with regard to the timeframe for performance of the project or task, the cost associated with performance of the project or task, any status updates with regard to performance of the project or task, and the like. The task monitoring sub-system 704 may associate this information with a data record corresponding to the project or task being performed within the task datastore 210. Status updates provided by third-party services 114 may be provided automatically to the member 110 via the application or web portal provided by the task facilitation service and to the representative 104. Alternatively, the status updates may be provided to the representative 104, which may provide these status updates to the member 110 over the communications session established between the member 110 and the representative 104 for the particular project or task or through other communication methods. If the representative 104 is performing the project or task for the benefit of the member 110, the representative 104 may provide status updates with regard to its performance of the project or task to the member 110 via the communications session facilitated between the member 110 and the representative 104 and corresponding to the project or task or through the application or web portal provided by the task facilitation service. The task monitoring sub-system 704 may associate these status updates with a data record corresponding to the task being performed within the task datastore 210.

In some instances, the task monitoring sub-system 704 may allow the third-party service or other service/entity engaged in performing the task to communicate with the member 110 directly to provide status updates related to the task. For instance, the task monitoring sub-system 704 may facilitate a communications session between the member 110 and the third-party service or other service/entity through which the member 110 and the third-party service or other service/entity may exchange messages related to the project or task being performed. This communications session may be provided through the interface specific to the project or task such that the communications session is distinct from the general communications session between the member 110 and the representative 104 and from any other project- or task-related communications sessions between the member 110 and the representative 104. In some instances, the third-party service or other service/entity may be added to the existing project- or task-specific communications session between the member 110 and the representative 104. This may allow the member 110 and the representative 104 to actively engage the third-party service or other service/entity as the third-party service or other service/entity performs the assigned project or task.

Once a project or task has been completed, the member 110 may provide feedback with regard to the performance of the representative 104 and/or third-party services 114 that performed the project or task according to the proposal option selected by the member 110. For instance, the member 110 may exchange one or more messages with the representative 104 over the project- or task-specific communications session to indicate its feedback with regard to the completion of the project or task. In an embodiment, the task monitoring sub-system 704 provides the feedback to the proposal creation sub-system 702, which may use a machine learning algorithm or artificial intelligence to process feedback provided by the member 110 to improve the recommendations provided by the proposal creation sub-system 702 for proposal options, third-party services 114 that may perform projects and tasks, and/or processes that may be performed by a representative 104 and/or third-party services 114 for completion of similar projects and tasks. For instance, if the proposal creation sub-system 702 detects that the member 110 is unsatisfied with the result provided by a third-party service 114 for a particular project or task, the proposal creation sub-system 702 may utilize this feedback to further train the machine learning algorithm or artificial intelligence to reduce the likelihood of the third-party service 114 being recommended for similar projects or tasks and to similarly-situated members. As another example, if the proposal creation sub-system 702 detects that the member 110 is pleased with the result provided by a representative 104 for a particular project or task, the proposal creation sub-system 702 may utilize this feedback to further train the machine learning algorithm or artificial intelligence to reinforce the operations performed by representatives for similar projects and tasks and/or for similarly-situated members.

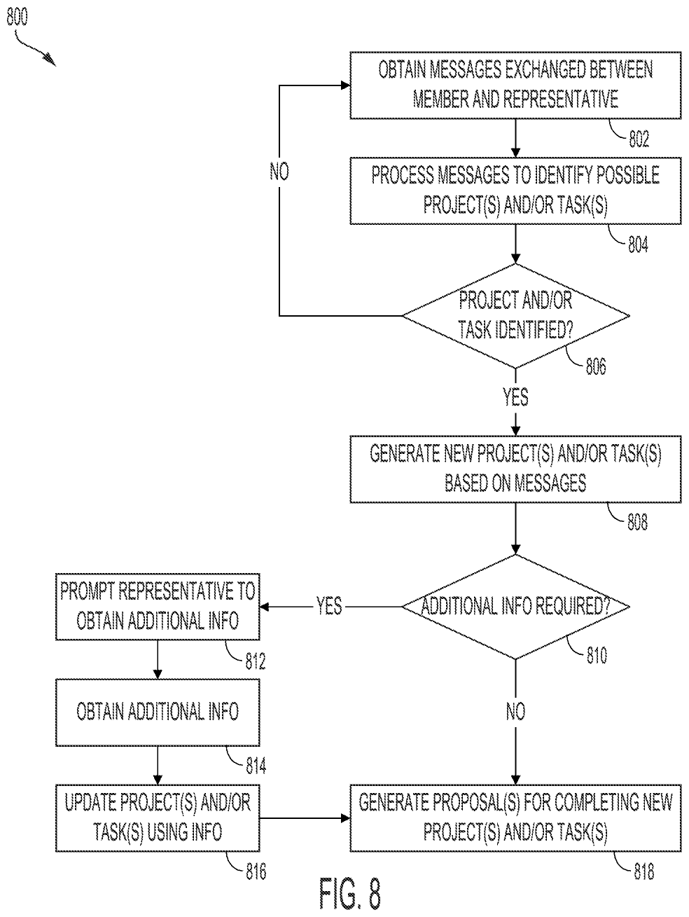

FIG. 8 shows an illustrative example of a process 800 for generating new projects and/or tasks based on messages exchanged between a member and an assigned representative in accordance with at least one embodiment. The process 800 may be performed by a task creation sub-system of the task recommendation system. As noted above, the task creation sub-system may implement a task creation machine learning module, which may include machine learning algorithms or artificial intelligence that may be used to dynamically, and in real-time, process messages between a member and a representative as these messages are exchanged to identify and automatically generate new projects and tasks. As such, the process 800 may be performed using, at least in part, the task creation machine learning module.

At step 802, the task creation sub-system obtains, in real-time, messages between a member and an assigned representative as these messages are being exchanged. For instance, the task creation sub-system may maintain a data stream or feed through which messages exchanged between the member and the representative are transmitted to the task creation sub-system automatically and in real-time. Alternatively, the task creation sub-system may actively monitor the communications session between the member and the representative to obtain any newly exchanged messages in real-time.

At step 804, the task creation sub-system can process the messages exchanged over the communications session between the member and the representative in real-time and as these messages are exchanged to automatically identify any projects and/or tasks that the member may wish to have performed by the representative and/or one or more third-party services for the member's benefit. The task creation sub-system may utilize a machine learning algorithm, such as an NLP algorithm, or other artificial intelligence to process these messages exchanged between the member and the representative over the communications session to identify possible projects and/or tasks that may be recommended to the member. For instance, the task creation sub-system may process any incoming messages from the member using NLP or other artificial intelligence to detect a new project and/or task that the member would like to have resolved or otherwise performed for the benefit of the member.

Based on the real-time processing of the exchanged messages between the member and the representative over the communications session, the task creation sub-system, at step 806, may determine whether a possible project and/or task has been identified. If the task creation sub-system has not identified a new project and/or task based on the processed messages, the task creation sub-system may continue to monitor the communications session to process any new messages exchanged between the member and the representative in real-time and as these messages are being exchanged, thereby restarting the process 800.

If the task creation sub-system determines, based on its processing of the exchanged messages between the member and the representative, identifies a new project or task that may be performed for the benefit of the member, the task creation sub-system, at step 808, may generate the new project or task. For instance, the task creation sub-system can use the member's messages, member-specific data (e.g., characteristics, demographics, location, historical responses to recommendations and proposals, etc.), data corresponding to similarly-situated members, and historical data corresponding to projects and tasks previously performed for the benefit of the member and the other similarly-situated members as input to a machine learning algorithm or artificial intelligence to generate a new project and/or task that may be recommended to the member.

As noted above, if the task creation sub-system automatically generates one or more new projects and/or tasks for the member based on the messages submitted by the member over the communications session, the task creation sub-system may automatically generate a specific communications session for each new project and/or task. This specific communications session corresponding to a particular project or task may be distinct from the communications session previously established between the member and the representative. Through this project- or task-specific communications session, the member and the representative may exchange messages related to the particular project or task. The implementation of project- or task-specific communications sessions may reduce the number of messages exchanged through other chat or communications sessions while ensuring that communications within these project- or task-specific communications sessions are relevant to the corresponding projects or tasks.

As noted above, the task creation sub-system may provide, for each identified project and/or task, a template through which the representative may define various parameters for the project and/or task. Each template may include different data fields for defining the project or task, whereby the different data fields may correspond to the project or task type or category for the project or task being defined. The representative may provide project or task information via these different data fields to define the project or task that may be submitted to the task creation sub-system for processing. The data fields presented in a template for a project or task can be selected based on a determination generated using a machine learning algorithm or artificial intelligence. For example, the task creation sub-system can use, as input to the machine learning algorithm or artificial intelligence, a member profile associated with the member and the selected template to identify which data fields may be omitted from the template when presented to the representative for definition of a new task or project. In some instances, the task creation sub-system may allow the representative to add, remove, and/or modify the data fields for the template. The task creation sub-system, in some instances, may utilize this change to the template to retrain the machine learning algorithm or artificial intelligence to improve the likelihood of providing templates to the representative without need for the representative to make any modifications to the template for defining a new project or task. As noted above, the task creation sub-system can also automatically populate the data fields presented in a template based on parameters of the new project or task as identified from member messages exchanged over the communications session facilitated between the member and the representative for the new project or task. For instance, the task creation sub-system may use NLP or other artificial intelligence to evaluate, in real-time, messages or other communications from the member as these messages or other communications are exchanged through the project- or task-specific communications session to identify various parameters for the new project or task.

At step 810, the task creation sub-system may automatically, and in real-time, determine whether additional information is required for creation of the new project or task. As noted above, the task creation sub-system, via the task creation machine learning module, may process a newly generated project and/or task and information corresponding to the member using a machine learning algorithm or artificial intelligence to automatically identify additional parameters for the project or task, as well as any additional information that may be required from the member for the generation of proposals. For instance, the task creation sub-system may use the generated project or task, information corresponding to the member, and historical data corresponding to projects and/or tasks performed for other similarly-situated members as input to the machine learning algorithm or artificial intelligence to identify any additional information that may be required of the member for defining the project and/or task.

If the task creation sub-system determines that additional information is required for the new project or task, the task creation sub-system, at step 812, may prompt the representative to obtain this additional information. For instance, the task creation sub-system may provide, to the representative, recommendations for questions that may be presented to the member regarding the project or task based on the member's preferences. For example, if the representative has not defined any budgets or budget restrictions for a new task or project, and the task creation sub-system determines that the member is budget conscious, the task creation sub-system may prompt the representative to communicate with the member via the project- or task-specific communications session corresponding to the new project or task to inquire about the member's budget for completion of the project or task. As noted above, the task creation sub-system can use a machine learning algorithm or artificial intelligence to determine what questions may be provided to the member to obtain the additional information. For instance, the task creation sub-system may use the parameters defined for the new project or task, the member profile associated with the member, and historical data corresponding to projects and/or tasks previously performed for the benefit of the member as input to the machine learning algorithm or artificial intelligence to determine the member's preferences and to identify questions that may be provided to the member based on these preferences to further define the parameters of the new project or task.

At step 814, the task creation sub-system may obtain the additional information required for creation of the new project or task. For instance, the task creation sub-system may obtain, via a representative console (such as representative console 402 illustrated and described above in connection with FIGS. 4-6) this additional information from the representative. Alternatively, if the task creation sub-system directly prompts the member for this additional information, the task creation sub-system may automatically obtain this additional information from the member via the project- or task-specific communications session between the member and the representative for the new project or task. In some instances, the task creation sub-system may automatically, and in real-time, process messages exchanged between the member and the representative over the project- or task-specific communications session using a machine learning algorithm (e.g., NLP) or other artificial intelligence to obtain this additional information for the new project or task. For instance, if the representative, over the project- or task-specific communications session, has prompted the member to provide this additional information, the task creation sub-system may automatically, and in real-time, process responses from the member to obtain the additional information required for the new project or task.

At step 816, the task creation sub-system may update the new project or task using the obtained additional information in order to complete definition of the new project or task. For instance, the task creation sub-system may access the template corresponding to the new project or task to update one or more data fields to incorporate the additional information. For instance, if the additional information specifies a budget for completion of the new project or task, the task creation sub-system may update a data field corresponding to the budget of the new project or task to input the specified budget. In some instances, the task creation sub-system may determine whether any additional information is still required for the new project or task, thereby returning to step 810 described above. If additional information is still required, the task creation sub-system may prompt the representative and/or member to provide this additional information for the new project or task.

If the task creation sub-system determines that the new project or task has been fully defined (e.g., no additional information is required), the task creation sub-system may provide the newly created project or task to the representative and/or task coordination system to cause the representative and/or the task coordination system, at step 818, to generate a proposal for completing the new project or task. For instance, the representative can utilize the task coordination system to generate one or more proposals for resolution of the project and/or task. In some examples, the representative may utilize a resource library maintained by the task coordination system to identify one or more third-party services and/or resources that may be used for performance of the project and/or task for the benefit of the member according to the one or more parameters identified by the representative and the task creation sub-system, as described above. A proposal may specify a timeframe for completion of the project and/or task, identification of any third-party services (if any) that are to be engaged for completion of the project and/or task, a budget estimate for completion of the project and/or task, resources or types of resources to be used for completion of the project and/or task, and the like. The representative may present the proposal to the member via the communications session corresponding to the new project or task to solicit a response from the member to either proceed with a particular proposal option presented in the proposal or to provide an alternative proposal option for completion of the project and/or task.

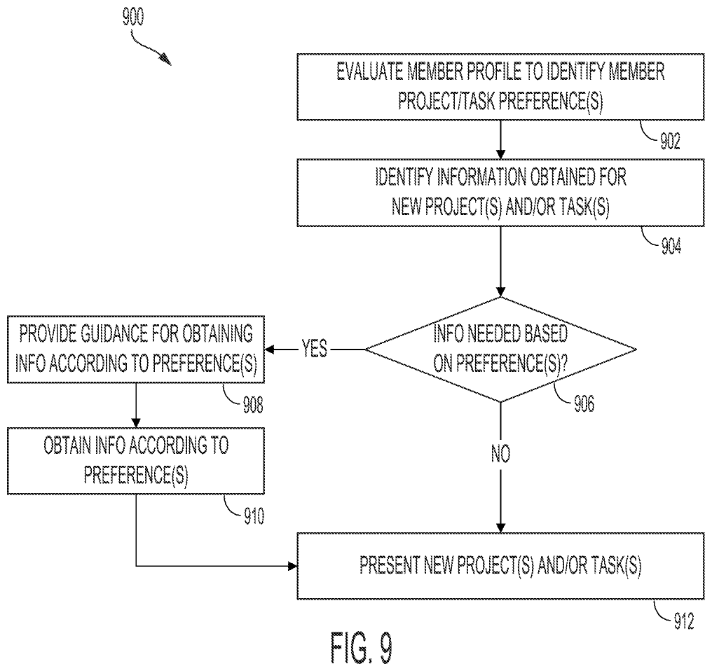

FIG. 9 shows an illustrative example of a process 900 for identifying additional information required from a member for defining new projects and/or tasks based on a member profile in accordance with at least one embodiment. The process 900 may be performed by a task creation machine learning module of the task creation sub-system. As noted above, the task creation machine learning module may include machine learning algorithms or artificial intelligence that may be used to dynamically, and in real-time, identifies information that may be required for defining a new project or task. It should be noted that the process 900 may be an extension of steps 810-814 of the process 800 described above in connection with FIG. 8.

At step 902, the task creation machine learning module may evaluate a member profile corresponding to the member to identify the member's project and task preferences. For instance, the task creation machine learning module may access a user datastore (such as user datastore 208 described above) to retrieve a member profile corresponding to the member for which a new project or task is being defined. The member profile may specify various preferences for different project and task types or categories. For instance, the member profile may specify that the member is budget conscious with regard to projects or tasks related to home and vehicle maintenance but not for other types of categories of projects and tasks. As another example, the member profile may specify that the member is only interested in high-end brands or services for its projects and tasks. As yet another example, the member profile may specify that the member only trusts brands or services having a review score above a minimum threshold value.

In some instances, the task creation machine learning module may evaluate the member profile using a machine learning algorithm or other artificial intelligence to determine the member's preferences for different project and task categories or types. The machine learning algorithm or artificial intelligence may be used to determine or recommend what information should be presented to the member and to similarly-situated members for similar projects and tasks or types of projects and tasks. The task creation machine learning module may monitor or track member interaction with the projects and tasks to determine the member's preferences regarding the information presented in these projects and tasks. Further, the task creation machine learning module may obtain data from the proposal creation sub-system to obtain any member preferences regarding information that is presented within proposals for different projects and tasks. Additionally, the task creation machine learning module may monitor or track any messages exchanged between the member and the representative related to projects and tasks to further identify the member's preferences. In some instances, the task creation machine learning module may solicit feedback from the member with regard to projects and tasks presented to the member to identify the member's preferences. This feedback and information garnered through member interaction with the representative regarding the projects and tasks and with these projects and tasks themselves may be used to retrain the machine learning algorithm or artificial intelligence to determine the member's preferences. The task creation machine learning module may further use the feedback and information garnered through member interaction with the representative to update the member profile for use in determining the member's preferences.

At step 904, the task creation machine learning module may identify information that has already been obtained and defined for the new projects and/or tasks. For instance, if a template has been used to begin definition of a new project or task, the task creation machine learning module may determine what information has been specified in the template within one or more data fields of the template. Accordingly, the task creation machine learning module may evaluate the template to identify any empty or incomplete data fields and to identify other data fields that may have been omitted from the template (e.g., certain templates may, by default, omit particular data fields).

At step 906, the task creation machine learning module may determine, based on the information garnered from the template for the new project or task and the member's preferences, whether additional information is required for the new project or task. For example, if the member, based on the member's preferences, is known to be budget conscious, and the representative and/or the task creation sub-system has not defined any budgets or budget restrictions for the task or project via the corresponding template, the task creation machine learning module may determine that additional information related to a budget for the new project or task is required. As another example, if the member prefers to have an understanding of the timeframes required for completion of a project or task, and no timeframe has been defined for completion of the new project or task, the task creation machine learning module may determine that additional information related to a timeframe for completion of the new project or task is required.

If the task creation machine learning module determines that additional information is required for defining the new project or task, the task creation machine learning module may, at step 908, provide guidance for obtaining this additional information according to the member's preferences. For instance, based on the identified information that may be required from the member, the task creation machine learning module may automatically generate recommendations for questions that may be presented to the member regarding the project or task based on the member's preferences. As noted above, the task creation machine learning module can use a machine learning algorithm or artificial intelligence to determine what questions may be provided to the member. For instance, the task creation machine learning module may use the parameters defined for the new project or task, the member's profile, and historical data corresponding to projects and/or tasks previously performed for the benefit of the member as input to the machine learning algorithm or artificial intelligence to identify questions that may be provided to the member based on the member's preferences to further define the parameters of the new project or task.

At step 910, the task creation machine learning module may obtain the additional information according to the member's preferences. For instance, the task creation machine learning module may obtain, via a representative console (such as representative console 402 illustrated and described above in connection with FIGS. 4-6), this additional information from the representative. Alternatively, if the task creation machine learning module directly prompts the member for this additional information, the task creation machine learning module may automatically obtain this additional information from the member via the project- or task-specific communications session between the member and the representative. In some instances, the task creation machine learning module may automatically, and in real-time, process messages exchanged between the member and the representative over the project- or task-specific communications session using a machine learning algorithm (e.g., NLP) or other artificial intelligence to obtain this additional information for the new project or task.

It should be noted that, in some embodiments, rather than obtaining additional information, the task creation machine learning module can receive an indication that the additional information is not required for the new project or task. For instance, the representative or member can indicate that the additional information identified by the task creation machine learning module is not required for one or more newly generated projects and/or tasks. As an example, the representative may indicate that, based on its knowledge of the member and/or in response to the member indicating that the additional information is not required, the additional information identified by the task creation machine learning module is not required for one or more newly generated projects and/or tasks. Accordingly, the task creation machine learning module may update the template for each project and/or task to omit this additional information and finalize creation of the new projects and/or tasks. Further, based on this feedback from the representative or member, the task creation machine learning module may update the machine learning algorithm or artificial intelligence used to identify what additional information may be required for new projects and tasks to decrease the likelihood of similar prompts for additional information being presented to the representative or member by the task creation machine learning module for similar projects and/or tasks and for similarly-situated members.

At step 912, the task creation machine learning module may present the new projects and/or tasks, including any additional information added to these new projects and/or tasks based on the member's preferences and responses. For instance, the task creation machine learning module can update the representative console to present these new projects and/or tasks to the representative. Through the representative console, the representative may review the new projects and/or tasks. For instance, the representative, through the representative console, may select a particular project or task in order to review the parameters associated with the project or task (e.g., timeframe for completion of the project or task, any third-party services to be engaged for completion of the project or task, any budget requirements, actions to be performed for the project or task, etc.). Further, the representative may access the template for the particular project or task to provide any additional information that may be required for the project or task that was not previously identified by the task creation machine learning module.

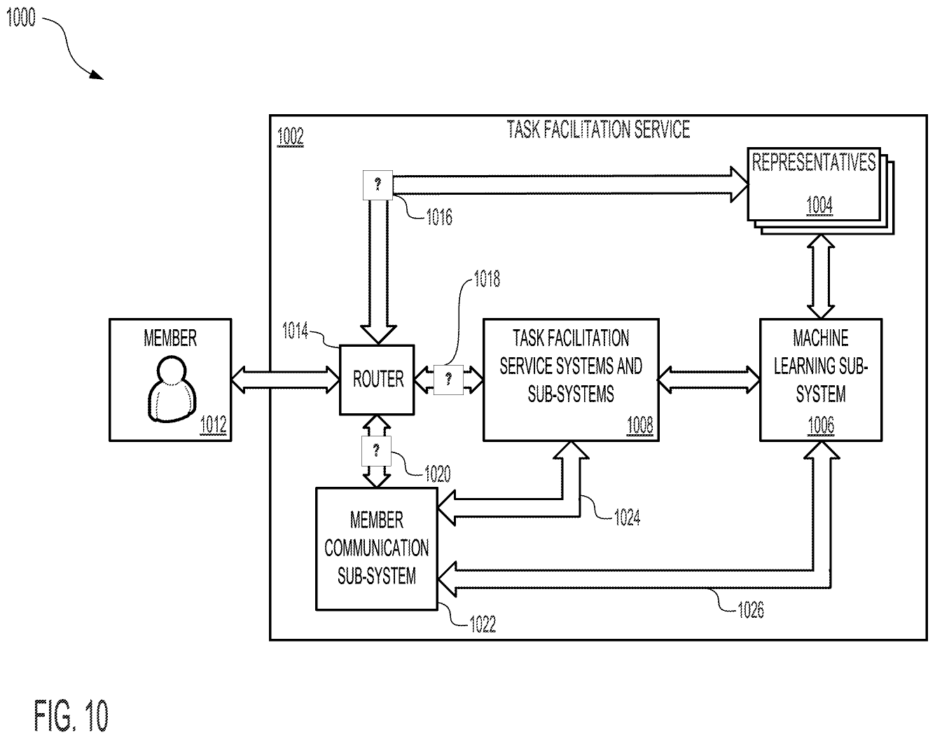

FIG. 10 shows an illustrative example of an environment 1000 in which communications with members are processed in accordance with at least one embodiment. In an embodiment, operations performed by representatives 1004 are partially and/or fully performed using one or more machine learning algorithms, artificial intelligence systems and/or computational models. For example, as the representatives 1004 perform or otherwise coordinate performance of tasks on behalf of a member 1012, the task facilitation service 1002 may update a profile of the member 1012 and/or a computational model of the profile of the member 1012.

In an embodiment, as the representatives 1004 perform or otherwise coordinate performance of tasks on behalf of a member 1012, the task facilitation service 1002 updates a profile of the member 1012 and/or a computational model of the profile of the member 1012 continuously. For example, as a member 1012 communicates with a system of the task facilitation service 1002, the task facilitation service 1002 may update the profile of the member 1012 and/or a computational model of the profile of the member 1012 continuously during the course of the interaction.

In an embodiment, as the representatives 1004 perform or otherwise coordinate performance of tasks on behalf of a member 1012, the task facilitation service 1002 updates a profile of the member 1012 and/or a computational model of the profile of the member 1012 dynamically. For example, as a task is performed on behalf of a member 1012, a vendor performing the task may provide regular updates to the task facilitation service 1002 and the task facilitation service 1002 may update the profile of the member 1012 and/or a computational model of the profile of the member 1012 dynamically at each update from the vendor.

In an embodiment, as the representatives 1004 perform or otherwise coordinate performance of tasks on behalf of a member 1012, the task facilitation service 1002 updates a profile of the member 1012 and/or a computational model of the profile of the member 1012 automatically. For example, when a proposal is generated for the member, the task facilitation service 1002 may update the profile of the member 1012 and/or a computational model of the profile of the member 1012 automatically as part of the proposal generation process.

In an embodiment, as the representatives 1004 perform or otherwise coordinate performance of tasks on behalf of a member 1012, the task facilitation service 1002 updates a profile of the member 1012 and/or a computational model of the profile of the member 1012 in real-time. For example, when a member 1012 accepts a proposal, the task facilitation service 1002 may update the profile of the member 1012 and/or a computational model of the profile of the member 1012 at the time that the proposal acceptance is provided, rather than delaying the update.

In an embodiment, the task facilitation service 1002 updates a profile of the member 1012 and/or a computational model of the profile of the member 1012 using a machine learning sub-system 1006 of the task facilitation service 1002. In an embodiment, a machine learning sub-system 1006 is a component of the task facilitation service 1002 that is configured to implement machine learning algorithms, artificial intelligence systems, and/or computation models. In an example, a machine learning sub-system 1006 may use various algorithms to train a machine learning model using sample and/or live data. Additionally, a machine learning sub-system 1006 may update the machine learning model as new data is received. In another example, the machine learning sub-system 1006 may train and/or update various artificial intelligence systems or generate, train and/or update various computational models. For example, a computational model of the profile of the member 1012 may be generated, trained and/or updated by the machine learning sub-system 1006 as new information is received about the member 1012.

In an embodiment, after the profile of the member 1012 and/or a computational model of the profile of the member 1012 has been updated over a period of time (e.g., six months, a year, etc.) and/or over a set of tasks (e.g., twenty tasks, thirty tasks, etc.), systems of the task facilitation service 1002 (e.g., a task recommendation system) utilize one or more machine learning algorithms, artificial intelligence systems and/or computational models to generate new tasks continuously, automatically, dynamically, and in real-time. For example, the task recommendation system may generate new tasks based on the various attributes of the member's profile (e.g., historical data corresponding to member-representative communications, member feedback corresponding to representative performance and presented tasks/proposals, etc.) with or without representative interaction. In an embodiment, systems of task facilitation service 1002 (e.g., a task recommendation system) can automatically communicate with the member 1012 to obtain any additional information needed and can also generate proposals that may be presented to the member 1012 for performance of these tasks.

In the example illustrated in FIG. 10, communications between the member 1012 and the task facilitation service 1002 may be routed to one or more entities within the task facilitation service 1002. The example illustrated in FIG. 10 shows a communication router 1014 (referred to in the illustration as a “router”) however, as may be contemplated and as illustrated in FIG. 10, the router 1014 is an abstract representation of one or more techniques for routing communications between entities. Accordingly, communications from the member 1012 to the task facilitation service 1002 may be routed to one or more entities of the task facilitation service and communications from the one or more entities of the task facilitation service 1002 may be routed back to the member 1012.

In the example illustrated in FIG. 10, the representatives 1004 can monitor communications between task facilitation service systems and/or sub-systems 1008 and the member 1012 to ensure that the interaction maintains a positive polarity as described herein because the communications can be routed 1016 to the representatives 1004 and also routed 1018 to task facilitation service systems and/or sub-systems 1008. For example, if a member 1012 is interacting with the task recommendation system, the representatives 1004 can determine whether the member 1012 is satisfied with the interaction. If the representatives 1004 determine that the conversation has a negative polarity (e.g., that the member 1012 is not satisfied with the interaction), the representatives 1004 may intervene to improve the interaction.

Similarly, other interactions between task facilitation service systems and/or sub-systems 1008 and the member 1012 may be routed 1020 to a member communication sub-system 1022 which may be configured to monitor the interactions between task facilitation service systems and/or sub-systems 1008 and the member 1012. In an embodiment, the member communication sub-system 1022 can be configured to intercept the interactions between task facilitation service systems and/or sub-systems 1008 and the member 1012 (using, for example, the router 1014). In such an embodiment, all such interactions can be routed 1020 between the member 1012 and the member communication sub-system 1022 and can be routed 1024 between the member communication sub-system 1022 and the task facilitation service systems and/or sub-systems 1008. In such an embodiment, interactions between the task facilitation service systems and/or sub-systems 1008 and the member 1012 may not be routed 1018 directly. In such an embodiment, the representatives 1004 may still monitor interactions between task facilitation service systems and/or sub-systems 1008 and the member 1012 to ensure that the interaction maintains a positive polarity as described above (e.g., by routing 1016 the interactions to the representatives 1004).

In an embodiment, the representatives 1004 can interact with the machine learning sub-system 1006 to update the profile of the member indicating changing member preferences based on an interaction between the representatives 1004 the member 1012. In an embodiment, the task facilitation service systems and/or sub-systems 1008 can interact with the machine learning sub-system 1006 to update the profile of the member when, for example, a proposal is accepted or rejected. Additionally, as illustrated in FIG. 10, the interactions between the task facilitation service 1002 and the member 1012 can be additionally routed 1026 between the member communication sub-system 1022 and the machine learning sub-system 1006. Accordingly, interactions between the member 1012 and, for example, a proposal creation sub-system may be used to update the profile of the member as a proposal is created.

Thus, unlike automated customer service systems and environments, wherein the systems and environment may have little or no knowledge of users interacting with agents and/or other automated systems, task facilitation service systems and/or sub-systems 1008 can update the profile of the member 1012 and/or a computational model of the profile of the member 1012 continuously, dynamically, automatically, and/or in real-time. For example, task facilitation service systems and/or sub-systems 1008 can update the profile of the member 1012 and/or a computational model of the profile of the member 1012 using the machine learning sub-system 1006 as described herein. Accordingly, task facilitation service systems and/or sub-systems 1008 can update the profile of the member 1012 and/or a computational model of the profile of the member 1012 to provide up-to-date information about the member based on the member's automatic interaction with the task facilitation service 1002, based on the member's interaction with the representative 1004, and/or based on tasks performed on behalf of the member 1012 over time. This information may also be updated continuously, automatically, dynamically, and/or in real-time as tasks and/or proposals are created, proposed, and performed for the member 1012. This information may also be used by the task facilitation service 1002 to anticipate, identify, and present appropriate or intelligent interactions with the member 1012 (e.g., in response to member 1012 queries, needs, and/or goals).

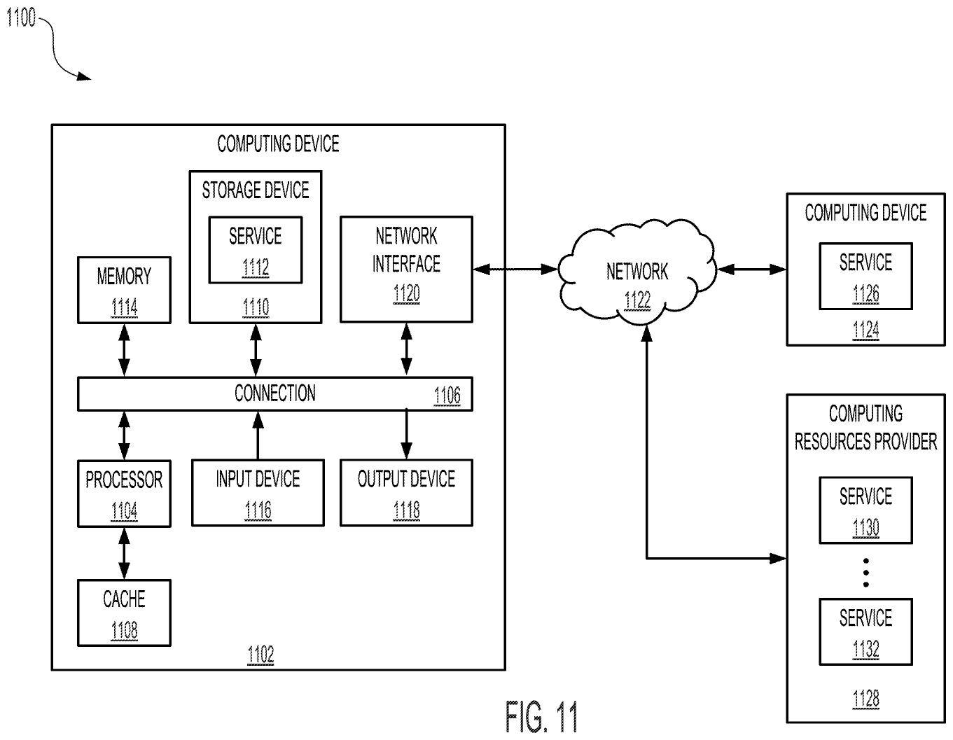

FIG. 11 illustrates a computing system architecture 1100, including various components in electrical communication with each other, in accordance with some embodiments. The example computing system architecture 1100 illustrated in FIG. 11 includes a computing device 1102, which has various components in electrical communication with each other using a connection 1106, such as a bus, in accordance with some implementations. The example computing system architecture 1100 includes a processing unit 1104 that is in electrical communication with various system components, using the connection 1106, and including the system memory 1114. In some embodiments, the system memory 1114 includes read-only memory (ROM), random-access memory (RAM), and other such memory technologies including, but not limited to, those described herein. In some embodiments, the example computing system architecture 1100 includes a cache 1108 of high-speed memory connected directly with, in close proximity to, or integrated as part of the processor 1104. The system architecture 1100 can copy data from the memory 1114 and/or the storage device 1110 to the cache 1108 for quick access by the processor 1104. In this way, the cache 1108 can provide a performance boost that decreases or eliminates processor delays in the processor 1104 due to waiting for data. Using modules, methods and services such as those described herein, the processor 1104 can be configured to perform various actions. In some embodiments, the cache 1108 may include multiple types of cache including, for example, level one (L1) and level two (L2) cache. The memory 1114 may be referred to herein as system memory or computer system memory. The memory 1114 may include, at various times, elements of an operating system, one or more applications, data associated with the operating system or the one or more applications, or other such data associated with the computing device 1102.

Other system memory 1114 can be available for use as well. The memory 1114 can include multiple different types of memory with different performance characteristics. The processor 1104 can include any general purpose processor and one or more hardware or software services, such as service 1112 stored in storage device 1110, configured to control the processor 1104 as well as a special-purpose processor where software instructions are incorporated into the actual processor design. The processor 1104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 1104 can be a microprocessor, a microcontroller, a digital signal processor (“DSP”), or a combination of these and/or other types of processors. In some embodiments, the processor 1104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1100, an input device 1116 can represent any number of input mechanisms, such as a microphone for speech, a touch-sensitive screen for gesture or graphical input, keyboard, mouse, motion input, pen, and other such input devices. An output device 1118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1100. In some embodiments, the input device 1116 and/or the output device 1118 can be coupled to the computing device 1102 using a remote connection device such as, for example, a communication interface such as the network interface 1120 described herein. In such embodiments, the communication interface can govern and manage the input and output received from the attached input device 1116 and/or output device 1118. As may be contemplated, there is no restriction on operating on any particular hardware arrangement and accordingly the basic features here may easily be substituted for other hardware, software, or firmware arrangements as they are developed.

In some embodiments, the storage device 1110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1110 can include hardware and/or software services such as service 1112 that can control or configure the processor 1104 to perform one or more functions including, but not limited to, the methods, processes, functions, systems, and services described herein in various embodiments. In some embodiments, the hardware or software services can be implemented as modules. As illustrated in example computing system architecture 1100, the storage device 1110 can be connected to other parts of the computing device 1102 using the system connection 1106. In an embodiment, a hardware service or hardware module such as service 1112, that performs a function can include a software component stored in a non-transitory computer-readable medium that, in connection with the necessary hardware components, such as the processor 1104, connection 1106, cache 1108, storage device 1110, memory 1114, input device 1116, output device 1118, and so forth, can carry out the functions such as those described herein.

The disclosed processed for generating and executing experience recommendations can be performed using a computing system such as the example computing system illustrated in FIG. 11, using one or more components of the example computing system architecture 1100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and functions for generating and executing experience recommendations described herein by, for example, executing code using a processor such as processor 1104 wherein the code is stored in memory such as memory 1114 as described herein. One or more of a user device, a provider server or system, a database system, or other such devices, services, or systems may include some or all of the components of the computing system such as the example computing system illustrated in FIG. 11, using one or more components of the example computing system architecture 1100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1114 can be coupled to the processor 1104 by, for example, a connector such as connector 1106, or a bus. As used herein, a connector or bus such as connector 1106 is a communications system that transfers data between components within the computing device 1102 and may, in some embodiments, be used to transfer data between computing devices. The connector 1106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1114 can also include magnetic or optical data storage media including read-only (e.g., CD ROM and DVD ROM) or otherwise (e.g., CD or DVD). The memory can be local, remote, or distributed.

As described above, the connector 1106 (or bus) can also couple the processor 1104 to the storage device 1110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 1110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1106 can also couple the processor 1104 to a network interface device such as the network interface 1120. The interface can include one or more of a modem or other such network interfaces including, but not limited to those described herein. It will be appreciated that the network interface 1120 may be considered to be part of the computing device 1102 or may be separate from the computing device 1102. The network interface 1120 can include one or more of an analog modem, Integrated Services Digital Network (ISDN) modem, cable modem, token ring interface, satellite transmission interface, or other interfaces for coupling a computer system to other computer systems. In some embodiments, the network interface 1120 can include one or more input and/or output (I/O) devices. The I/O devices can include, by way of example but not limitation, input devices such as input device 1116 and/or output devices such as output device 1118. For example, the network interface 1120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 1102 can be connected to one or more additional computing devices such as computing device 1124 via a network 1122 using a connection such as the network interface 1120. In such embodiments, the computing device 1124 may execute one or more services 1126 to perform one or more functions under the control of, or on behalf of, programs and/or services operating on computing device 1102. In some embodiments, a computing device such as computing device 1124 may include one or more of the types of components as described in connection with computing device 1102 including, but not limited to, a processor such as processor 1104, a connection such as connection 1106, a cache such as cache 1108, a storage device such as storage device 1110, memory such as memory 1114, an input device such as input device 1116, and an output device such as output device 1118. In such embodiments, the computing device 1124 can carry out the functions such as those described herein in connection with computing device 1102. In some embodiments, the computing device 1102 can be connected to a plurality of computing devices such as computing device 1124, each of which may also be connected to a plurality of computing devices such as computing device 1124. Such an embodiment may be referred to herein as a distributed computing environment.

The network 1122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1122 can be wired connections, wireless connections, or combinations thereof. Communications via the network 1122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1122, within the computing device 1102, within the computing device 1124, or within the computing resources provider 1128 can include information, which also may be referred to herein as content. The information may include text, graphics, audio, video, haptics, and/or any other information that can be provided to a user of the computing device such as the computing device 1102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1102 and presented to a user of the computing device 1102 using forms that are perceptible via sight, sound, smell, taste, touch, or other such mechanisms. In some embodiments, communications over the network 1122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 1102 and/or the computing device 1124 can be connected to a computing resources provider 1128 via the network 1122 using a network interface such as those described herein (e.g. network interface 1120). In such embodiments, one or more systems (e.g., service 1130 and service 1132) hosted within the computing resources provider 1128 (also referred to herein as within “a computing resources provider environment”) may execute one or more services to perform one or more functions under the control of, or on behalf of, programs and/or services operating on computing device 1102 and/or computing device 1124. Systems such as service 1130 and service 1132 may include one or more computing devices such as those described herein to execute computer code to perform the one or more functions under the control of, or on behalf of, programs and/or services operating on computing device 1102 and/or computing device 1124.

For example, the computing resources provider 1128 may provide a service, operating on service 1130 to store data for the computing device 1102 when, for example, the amount of data that the computing device 1102 exceeds the capacity of storage device 1110. In another example, the computing resources provider 1128 may provide a service to first instantiate a virtual machine (VM) on service 1132, use that VM to access the data stored on service 1132, perform one or more operations on that data, and provide a result of those one or more operations to the computing device 1102. Such operations (e.g., data storage and VM instantiation) may be referred to herein as operating “in the cloud,” “within a cloud computing environment,” or “within a hosted virtual machine environment,” and the computing resources provider 1128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 1128 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 1130 and service 1132 may implement versions of various services (e.g., the service 1112 or the service 1126) on behalf of, or under the control of, computing device 1102 and/or computing device 1124. Such implemented versions of various services may involve one or more virtualization techniques so that, for example, it may appear to a user of computing device 1102 that the service 1112 is executing on the computing device 1102 when the service is executing on, for example, service 1130. As may also be contemplated, the various services operating within the computing resources provider 1128 environment may be distributed among various systems within the environment as well as partially distributed onto computing device 1124 and/or computing device 1102.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1102) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 6-8). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 1102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method, comprising:
receiving in real-time a set of messages between a member and a representative as the set of messages are being exchanged;
automatically identifying in real-time a task performable on behalf of the member and one or more parameters associated with the task, wherein the task and the one or more parameters associated with the task are identified based on the set of messages;
identifying additional information required for defining the task, wherein the additional information is identified using a trained machine learning algorithm, and wherein the trained machine learning algorithm uses a profile corresponding to the member, the task, and the one or more parameters associated with the task to identify the additional information;
dynamically generating one or more prompts for the additional information, wherein when the one or more prompts are generated, the one or more prompts are provided to the member to obtain the additional information;
updating the task based on the additional information;
performing the task, wherein the task is performed according to the one or more parameters associated with the task and the additional information; and
updating the trained machine learning algorithm, wherein the trained machine learning algorithm is updated using the task, the one or more parameters, the additional information, and the profile corresponding to the member.

2. The computer-implemented method of claim 1, further comprising:
monitoring in real-time new messages between the member and the representative as the new messages are exchanged, wherein the new messages correspond to the one or more prompts for the additional information; and
processing the new messages using a Natural Language Processing (NLP) algorithm to obtain the additional information.

3. The computer-implemented method of claim 1, further comprising:
facilitating a communications session corresponding to the task, wherein the communications session is facilitated between the member and the representative; and
automatically presenting the one or more prompts for the additional information through the communications session.

4. The computer-implemented method of claim 1, further comprising:
generating one or more proposal options for completion of the task, wherein the one or more proposal options are generated based on the task and the profile corresponding to the member, and wherein when a proposal option is selected, the task is performed according to the selected proposal option.

5. The computer-implemented method of claim 1, further comprising:
selecting a task template, wherein the task template is selected based on the one or more parameters associated with the task;
updating the task template according to the one or more parameters; and
completing the task template using the additional information, wherein when the task template is completed, the task is presented.

6. The computer-implemented method of claim 1, further comprising:
providing the one or more prompts to the representative, wherein when the one or more prompts are received by the representative, the representative presents one or more new messages including the one or more prompts to the member.

7. The computer-implemented method of claim 1, further comprising:
receiving in real-time a new message exchanged between the member and the representative, wherein the new message indicates a request for new information required for the task;
modifying the task to incorporate the new information; and
updating the trained machine learning algorithm and the profile corresponding to the member based on the request.

8. A system, comprising:
one or more processors; and
memory storing thereon instructions that, as a result of being executed by the one or more processors, cause the system to:
receive in real-time a set of messages between a member and a representative as the set of messages are being exchanged;
automatically identify in real-time a task performable on behalf of the member and one or more parameters associated with the task, wherein the task and the one or more parameters associated with the task are identified based on the set of messages;
identify additional information required for defining the task, wherein the additional information is identified using a trained machine learning algorithm, and wherein the trained machine learning algorithm uses a profile corresponding to the member, the task, and the one or more parameters associated with the task to identify the additional information;
dynamically generate one or more prompts for the additional information, wherein when the one or more prompts are generated, the one or more prompts are provided to the member to obtain the additional information;
update the task based on the additional information;
perform the task, wherein the task is performed according to the one or more parameters associated with the task and the additional information; and
update the trained machine learning algorithm, wherein the trained machine learning algorithm is updated using the task, the one or more parameters, the additional information, and the profile corresponding to the member.

9. The system of claim 8, wherein the instructions further cause the system to:
monitor in real-time new messages between the member and the representative as the new messages are exchanged, wherein the new messages correspond to the one or more prompts for the additional information; and
process the new messages using a Natural Language Processing (NLP) algorithm to obtain the additional information.

10. The system of claim 8, wherein the instructions further cause the system to:
facilitate a communications session corresponding to the task, wherein the communications session is facilitated between the member and the representative; and
automatically present the one or more prompts for the additional information through the communications session.

11. The system of claim 8, wherein the instructions further cause the system to:
generate one or more proposal options for completion of the task, wherein the one or more proposal options are generated based on the task and the profile corresponding to the member, and wherein when a proposal option is selected, the task is performed according to the selected proposal option.

12. The system of claim 8, wherein the instructions further cause the system to:
select a task template, wherein the task template is selected based on the one or more parameters associated with the task;
update the task template according to the one or more parameters; and
complete the task template using the additional information, wherein when the task template is completed, the task is presented.

13. The system of claim 8, wherein the instructions further cause the system to:
provide the one or more prompts to the representative, wherein when the one or more prompts are received by the representative, the representative presents one or more new messages including the one or more prompts to the member.

14. The system of claim 8, wherein the instructions further cause the system to:
receive in real-time a new message exchanged between the member and the representative, wherein the new message indicates a request for new information required for the task;
modify the task to incorporate the new information; and
update the trained machine learning algorithm and the profile corresponding to the member based on the request.

15. A non-transitory, computer-readable storage medium storing thereon executable instructions that, as a result of being executed by a computer system, cause the computer system to:
receive in real-time a set of messages between a member and a representative as the set of messages are being exchanged;
automatically identify in real-time a task performable on behalf of the member and one or more parameters associated with the task, wherein the task and the one or more parameters associated with the task are identified based on the set of messages;
identify additional information required for defining the task, wherein the additional information is identified using a trained machine learning algorithm, and wherein the trained machine learning algorithm uses a profile corresponding to the member, the task, and the one or more parameters associated with the task to identify the additional information;
dynamically generate one or more prompts for the additional information, wherein when the one or more prompts are generated, the one or more prompts are provided to the member to obtain the additional information;
update the task based on the additional information;
perform the task, wherein the task is performed according to the one or more parameters associated with the task and the additional information; and
update the trained machine learning algorithm, wherein the trained machine learning algorithm is updated using the task, the one or more parameters, the additional information, and the profile corresponding to the member.

16. The non-transitory, computer-readable storage medium of claim 15, wherein the executable instructions further cause the computer system to:
monitor in real-time new messages between the member and the representative as the new messages are exchanged, wherein the new messages correspond to the one or more prompts for the additional information; and
process the new messages using a Natural Language Processing (NLP) algorithm to obtain the additional information.

17. The non-transitory, computer-readable storage medium of claim 15, wherein the executable instructions further cause the computer system to:
facilitate a communications session corresponding to the task, wherein the communications session is facilitated between the member and the representative; and
automatically present the one or more prompts for the additional information through the communications session.

18. The non-transitory, computer-readable storage medium of claim 15, wherein the executable instructions further cause the computer system to:
generate one or more proposal options for completion of the task, wherein the one or more proposal options are generated based on the task and the profile corresponding to the member, and wherein when a proposal option is selected, the task is performed according to the selected proposal option.

19. The non-transitory, computer-readable storage medium of claim 15, wherein the executable instructions further cause the computer system to:
select a task template, wherein the task template is selected based on the one or more parameters associated with the task;
update the task template according to the one or more parameters; and
complete the task template using the additional information, wherein when the task template is completed, the task is presented.

20. The non-transitory, computer-readable storage medium of claim 15, wherein the executable instructions further cause the computer system to:
provide the one or more prompts to the representative, wherein when the one or more prompts are received by the representative, the representative presents one or more new messages including the one or more prompts to the member.

21. The non-transitory, computer-readable storage medium of claim 15, wherein the executable instructions further cause the computer system to:
receive in real-time a new message exchanged between the member and the representative, wherein the new message indicates a request for new information required for the task;
modify the task to incorporate the new information; and
update the trained machine learning algorithm and the profile corresponding to the member based on the request.
